(19) United States
(12) Patent Application Publication
(10) Pub. No.: US 2024/0353118 A1
(43) Pub. Date: Oct. 24, 2024

(54) MOUNTING DEVICE AND AIR CONDITIONING APPARATUS INCLUDING THE SAME

(71) Applicant: SAMSUNG ELECTRONICS CO., LTD., Suwon-si (KR)

(72) Inventors: Bohyun KIM, Suwon-si (KR); Jihong KIM, Suwon-si (KR); Juwan PARK, Suwon-si (KR); Kyeongae LEE, Suwon-si (KR); Changsik LEE, Suwon-si (KR); Sunghyun CHUN, Suwon-si (KR); Wonhee LEE, Suwon-si (KR)

(73) Assignee: SAMSUNG ELECTRONICS CO., LTD., Suwon-si (KR)

(21) Appl. No.: 18/593,668

(22) Filed: Mar. 1, 2024

Related U.S. Application Data
(63) Continuation of application No. PCT/KR2024/002029, filed on Feb. 13, 2024.

(30) Foreign Application Priority Data
Apr. 20, 2023 (KR) 10-2023-0052254
Apr. 20, 2023 (KR) 10-2023-0052255
Jul. 7, 2023 (KR) 10-2023-0088692

(51) Int. Cl. F24F 1/031

(52) U.S. Cl. CPC F24F 1/031

(57) ABSTRACT

A mounting device configured to mount an air conditioner on a window frame, includes: a fixing frame configured to hold the air conditioner and be fixable to a lower portion of the window frame; a moving frame configured to move up and down with respect to the fixing frame and to be fixable to an upper portion of the window frame; and an indicator disposed on the moving frame and configured to contact the upper portion of the window frame, wherein the indicator includes: a first indicating portion configured to be visible from an outside of the moving frame when the moving frame is not fixed to the upper portion of the window frame; and a second indicating portion different from the first indicating portion, and configured to be visible from the outside of the moving frame when the moving frame is fixed to the upper portion.

### CROSS-REFERENCE TO RELATED APPLICATIONS

This application is a by-pass continuation of International Application No. PCT/KR2024/002029, filed on Feb. 13, 2024, which is based on and claims priority to Korean Patent Application No. 10-2023-0052254, filed on Apr. 20, 2023, Korean Patent Application No. 10-2023-0052255, filed on Apr. 20, 2023, and Korean Patent Application No. 10-2023-0088692, filed on Jul. 7, 2023, all filed in the Korean Intellectual Property Office, the disclosures of which are incorporated by reference herein in their entireties.

### BACKGROUND

### 1. Field

The present disclosure relates to a mounting device including an improved structure and an air conditioning apparatus including the same.

### 2. Description of Related Art

An air conditioner is a device that performs functions such as air purification, ventilation, humidity control, cooling, or heating in an air conditioning space, and refers to a device equipped with at least one of these functions.

The air conditioner may cool or heat a space using a refrigeration cycle. The air conditioner may include a compressor, a condenser, an expansion device, an evaporator, and a pipe. A refrigerant may circulate along the pipes through the compressor, the condenser, the expansion device, and the evaporator.

The air conditioners may be classified into a separate air conditioner and an integrated air conditioner. The separate air conditioner may include an indoor unit disposed indoors and an outdoor unit disposed outdoors. In the integrated air conditioner, both an indoor unit and an outdoor unit may be disposed in a single housing.

For example, a mounting device may be needed to mount an air conditioner to a structure. The mounting device may be mounted on the structure, and the air conditioner may be mounted on the mounting device.

### SUMMARY

One or more embodiments of the present disclosure provide a mounting device including an indicator capable of checking whether the mounting device is mounted on a structure or not.

One or more embodiments of the present disclosure also provide a mounting device including an indicator capable of checking whether an air conditioner is mounted on the mounting device.

One or more embodiments of the present disclosure also provide a mounting device with improved usability.

One or more embodiments of the present disclosure also provide a mounting device with improved safety of use.

One or more embodiments of the present disclosure also provide an air conditioning apparatus including a mounting device including an improved structure.

The disclosure is not limited to the above, and other objectives may become apparent to those of ordinary skill in the art based on the following descriptions.

According to an aspect of the disclosure, a mounting device configured to mount an air conditioner on a window frame, includes: a fixing frame configured to hold the air conditioner and to be fixable to a lower portion of the window frame; a moving frame configured to move up and down with respect to the fixing frame and to be fixable to an upper portion of the window frame; and an indicator disposed on the moving frame and configured to contact the upper portion of the window frame, wherein the indicator includes: a first indicating portion configured to be visible from an outside of the moving frame when the moving frame is not fixed to the upper portion of the window frame; and a second indicating portion that is different from the first indicating portion, and configured to be visible from the outside of the moving frame when the moving frame is fixed to the upper portion of the window frame.

The indicator may be configured to switch from a display to the outside of the moving frame of the first indicating portion to a display to the outside of the moving from of the second indicating portion based on the indicator being pressed against the upper portion of the window frame.

The indicator may further include a moving member protruding from the moving frame and configured to be movably pressed against the upper portion of the window frame, and the moving member may include the first indicating portion and the second indicating portion.

The indicator may further include a spring configured to elastically bias the moving member toward the upper portion of the window frame.

The moving member may be further configured to move between a first position maximally protruding from the moving frame and a second position pressed from the first position through contact with the upper portion of the window frame.

The first indicating portion may be below the second indicating portion. When the moving member is in the first position, the first indicating portion may be exposed to the outside of the moving frame. When the moving member is in the second position, the second indicating portion may be exposed to the outside of the moving frame.

The moving member may further include: a contact portion exposed to the outside of the moving frame and configured to be in contact with the upper portion of the window frame; an indicating panel below the contact portion and including the first indicating portion and the second indicating portion; and a connection portion connecting the contact portion and the indicating panel.

The moving frame may include: a first side frame portion extending along a moving direction of the moving frame; a second side frame portion extending parallel to the first side frame portion; an upper frame portion connecting the first side frame portion and the second side frame portion and configured to be fixed to the upper portion of the window frame; a screen covering a region surrounded by the fixing frame, the first side frame portion, the second side frame portion, and the upper frame portion, and accommodating the indicating panel; and an opening provided in the screen and exposing at least one of the first indicating portion or the second indicating portion to an outside of the screen.

The first indicating portion may include a first color; and the second indicating portion may include a second color that is different from the first color.

The indicator may be a first indicator, the mounting device may further include a second indicator in the fixing frame, and the second indicator may include: a third indicating portion configured to be visible from an outside of the fixing frame when the air conditioner is not fixed to the fixing frame; and a fourth indicating portion distinct from the third indicating portion and configured to be visible from the outside of the fixing frame when the air conditioner is fixed to the fixing frame.

The second indicator may include: a moving bracket configured to be movable with respect to the fixing frame by being pressed by the air conditioner; and an opening formed on the moving bracket and configured to expose at least one of the third indicating portion or the fourth indicating portion to the outside of the fixing frame.

The second indicator may further include a spring including one end coupled to the moving bracket and another end coupled to the fixing frame.

The moving bracket may further include a hook configured to be inserted into a hook hole formed in the air conditioner, the moving bracket may be configured to move in a first direction while the hook is pressed against a hole edge portion forming the hook hole, and the spring may be configured to move the moving bracket in a second direction opposite to the first direction when the hook is fixed to the air conditioner through the hook hole.

The hook may include: a hook body configured to be inserted into the hook hole; and a hook protrusion protruding from the hook body toward the second direction and configured to be pressed against the hole edge portion.

The third indicating portion may include a first color; and the fourth indicating portion may include a second color that is different from the first color.

According to an aspect of the disclosure, a mounting device configured to mount an air conditioner on a window frame, includes: a fixing frame configured to hold the air conditioner and to be fixable to a lower portion of the window frame; and an indicator in the fixing frame, the indicator including: a first indicating portion configured to be visible from an outside of the fixing frame when the air conditioner is not fixed to the fixing frame; and a second indicating portion distinct from the first indicating portion and configured to be visible from the outside of the fixing frame when the air conditioner is fixed to the fixing frame.

The indicator may include: a moving bracket configured to be movable with respect to the fixing frame by being pressed by the air conditioner; and an opening formed on the moving bracket and configured to expose at least one of the first indicating portion or the second indicating portion to the outside of the fixing frame.

The indicator may further include a spring including one end coupled to the moving bracket and another end coupled to the fixing frame.

The moving bracket may further include a hook configured to be inserted into a hook hole formed in the air conditioner, the moving bracket may be configured to move in a first direction while the hook is pressed against a hole edge portion forming the hook hole, and the spring may be configured to move the moving bracket in a second direction opposite to the first direction when the hook is fixed to the air conditioner through the hook hole.

The hook may include: a hook body configured to be inserted into the hook hole; and a hook protrusion protruding from the hook body toward the second direction and configured to be pressed against the hole edge portion.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating an air conditioning apparatus according to an embodiment;

FIG. 2 is a perspective view illustrating an air conditioner according to an embodiment;

FIG. 3 is a perspective view illustrating the air conditioner of FIG. 2 when viewed from another direction;

FIG. 4 is a planar cross-sectional view of the air conditioner according to an embodiment;

FIG. 5 is a perspective view of a mounting device according to an embodiment;

FIG. 6 is an exploded view of the mounting device according to an embodiment;

FIG. 7 is a perspective view of a fixing frame according to an embodiment;

FIG. 8 is a perspective view of a moving frame according to an embodiment;

FIG. 9 is a partially enlarged view of the moving frame according to an embodiment;

FIG. 10 is a perspective view of a first indicator according to an embodiment;

FIG. 11 is an exploded view of the first indicator according to an embodiment;

FIG. 12 is a view illustrating an example in which the mounting device is not fixed to a structure;

FIG. 13 is a view schematically illustrating a portion of a side cross-section of the state shown in FIG. 12;

FIG. 14 is a view schematically illustrating a portion of a front surface of the state shown in FIG. 12;

FIG. 15 is a view illustrating an example in which the mounting device is fixed to the structure;

FIG. 16 is a view schematically illustrating a portion of a side cross-section of the state shown in FIG. 15;

FIG. 17 is a view schematically illustrating a portion of a front surface of the state shown in FIG. 15;

FIG. 18 is a partially enlarged view of the fixing frame according to an embodiment;

FIG. 19 is a view illustrating a state in which a portion of the fixing frame and a second indicator according to an embodiment are disassembled;

FIG. 20 is a view illustrating an example in which the air conditioner is mounted on the mounting device;

FIG. 21 is a view illustrating an example in which the air conditioner is not fixed to the mounting device;

FIG. 22 is a view schematically illustrating a portion of a front surface of the state shown in FIG. 21;

FIG. 23 is a planar cross-sectional view taken along line B-B′ shown in FIG. 22;

FIG. 24 is a view illustrating an example in which the air conditioner is fixed to the mounting device;

FIG. 25 is a view schematically illustrating a portion of a front surface of the state shown in FIG. 24;

FIG. 26 is a planar cross-sectional view taken along line C-C′ shown in FIG. 25;

FIG. 27 is a view schematically illustrating an example in which the air conditioner according to an embodiment includes a switch;

FIG. 28 is a view schematically illustrating a portion of a planar cross-section of the air conditioner shown in FIG. 27 when the air conditioner is not fixed to the mounting device; and

FIG. 29 is a view schematically illustrating a portion of a planar cross-section of the air conditioner shown in FIG. 27 when the air conditioner is fixed to the mounting device.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The terms “A or B,” “at least one of A or B,” or “at least one of A and B” used herein may include any and all combinations of one or more of the associated listed items.

The term of “and/or” includes a plurality of combinations of relevant items or any one item among a plurality of relevant items.

The term “part”, “module”, or “component” may be implemented in hardware or software. In some embodiments, a plurality of “parts”, “modules”, and “components” may be implemented as a single component, or a single “part”, “module”, or “component” may comprise multiple components.

Herein, the expressions “a first”, “a second”, “the first”, “the second”, etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

An air conditioner according to various embodiments is a device that performs functions such as purification, ventilation, humidity control, cooling or heating in an air conditioning space (hereinafter referred to as “indoor space”), and particularly a device having at least one of these functions.

According to one or more embodiments, an air conditioner may include a heat pump device to perform a cooling function or a heating function. The heat pump device may include a refrigeration cycle in which a refrigerant is circulated through a compressor, a first heat exchanger, and an expansion device and a second heat exchanger. All components of the heat pump device may be embedded in one housing forming an exterior of an air conditioner, which includes a window-type air conditioner or a portable air conditioner. On the other hand, some components of the heat pump device may be divided and embedded in a plurality of housings forming a single air conditioner, which includes a wall-mounted air conditioner, a stand-type air conditioner, and a system air conditioner.

The air conditioner including the plurality of housings may include at least one outdoor unit installed outdoors and at least one indoor unit installed indoors. For example, the air conditioner may be provided in such a way that a single outdoor unit and a single indoor unit are connected through a refrigerant pipe. Alternatively, the air conditioner may be provided in such a way that a single outdoor unit is connected to two or more indoor units through a refrigerant pipe. Alternatively, the air conditioner may be provided in such a way that two or more outdoor units and two or more indoor units are connected through a plurality of refrigerant pipes.

The outdoor unit may be electrically connected to the indoor unit. For example, information (or commands) for controlling the air conditioner may be received through an input interface provided in the outdoor unit or the indoor unit. The outdoor unit and the indoor unit may operate simultaneously or sequentially in response to a user input.

The air conditioner may include an outdoor heat exchanger provided in the outdoor unit, an indoor heat exchanger provided in the indoor unit, and a refrigerant pipe connecting the outdoor heat exchanger and the indoor heat exchanger.

The outdoor heat exchanger may be configured to exchange heat between a refrigerant and outdoor air through a phase change of the refrigerant (e.g., evaporation or condensation). For example, while the refrigerant is condensed in the outdoor heat exchanger, the refrigerant may radiate heat to the outdoor air. While the refrigerant flowing in the outdoor heat exchanger evaporates, the refrigerant may absorb heat from the outdoor air.

The indoor unit is installed indoors. For example, according to the arrangement method of the indoor unit, the air conditioner may be classified into a ceiling-type indoor unit, a stand-type indoor unit, a wall-mounted indoor unit, and the like. For example, the ceiling-type indoor unit may be classified into a 4-way type indoor unit, a 1-way type indoor unit, a duct type indoor unit and the like according to a method of discharging air.

As mentioned above, the indoor heat exchanger may be configured to exchange heat between a refrigerant and outdoor air through a phase change of the refrigerant (e.g., evaporation or condensation). For example, while the refrigerant evaporates in the indoor unit, the refrigerant may absorb heat from the indoor air. The indoor space may be cooled by blowing the indoor air cooled through the cooled indoor heat exchanger. While the refrigerant is condensed in the indoor heat exchanger, the refrigerant may radiate heat to the indoor air. The indoor space may be heated by blowing the indoor air heated through the high-temperature indoor heat exchanger.

In other words, the air conditioner may perform a cooling or heating function through a phase change process of a refrigerant circulating between the outdoor heat exchanger and the indoor heat exchanger. To circulate the refrigerant, the air conditioner may include a compressor for compressing the refrigerant. The compressor may intake refrigerant gas through an inlet and compress the refrigerant gas. The compressor may discharge high-temperature and high-pressure refrigerant gas through an outlet. The compressor may be disposed inside the outdoor unit.

Through the refrigerant pipe, the refrigerant may be sequentially circulated through the compressor, the outdoor heat exchanger, the expansion device, and the indoor heat exchanger or sequentially circulated through the compressor, the indoor heat exchanger, the expansion device, and the outdoor heat exchanger.

For example, in the air conditioner, when a single outdoor unit and a single indoor unit are directly connected through a refrigerant pipe, the refrigerant may be circulated between the single outdoor unit and the single indoor unit through the refrigerant pipe.

For example, in the air conditioner, when a single outdoor unit is connected to two or more indoor units through a refrigerant pipe, the refrigerant may flow from the single outdoor unit to the plurality of indoor units through branched refrigerant pipes. Refrigerants discharged from the plurality of indoor units may be combined and circulated to the outdoor unit. For example, through a separate refrigerant pipe, each of the plurality of indoor units may be directly connected in parallel to the single outdoor unit.

Each of the plurality of indoor units may be operated independently according to an operation mode set by a user. In other words, some of the plurality of indoor units may be operated in a cooling mode while others of the plurality of indoor units is operated in a heating mode. At this time, the refrigerant may be selectively introduced into each indoor unit in a high-pressure state or a low-pressure state, discharged, and circulated to the outdoor unit along a circulation path that is designated through a flow path switching valve to be described later.

For example, in the air conditioner, when two or more outdoor units and two or more indoor units are connected through the plurality of refrigerant pipes, refrigerants discharged from the plurality of outdoor units may be combined and flow through one refrigerant pipe, and then diverged again at a certain point and introduced into the plurality of indoor units.

All of the plurality of outdoor units may be driven or at least some of the plurality of outdoor units may not be driven according to a driving load according to an operation amount of the plurality of indoor units. At this time, through a flow path switching valve, the refrigerant may be provided to be introduced into and circulated to an outdoor unit that is selectively driven. The air conditioner may include the expansion device to lower the pressure of the refrigerant flowing into the heat exchanger. For example, the expansion device may be disposed inside the indoor unit or inside the outdoor unit, or disposed inside the indoor unit and the outdoor unit.

The expansion device may lower a temperature and pressure of the refrigerant by using a throttling effect. The expansion device may include an orifice configured to reduce a cross-sectional area of a flow path. A temperature and pressure of the refrigerant passing through the orifice may be lowered.

For example, the expansion device may be implemented as an electronic expansion valve configured to adjust an opening ratio (a ratio of a cross-sectional area of a flow path of a valve in a partially opened state to a cross-sectional area of the flow path of the valve in a fully open state). According to the opening ratio of the electronic expansion valve, the amount of refrigerant passing through the expansion device may be adjusted.

The air conditioner may further include a flow path switching valve disposed on the refrigerant circulation path. The flow path switching valve may include a 4-way valve. The flow path switching valve may determine a refrigerant circulation path depending on an operation mode of the indoor unit (e.g., cooling operation or heating operation). The flow path switching valve may be connected to the outlet of the compressor.

The air conditioner may include an accumulator. The accumulator may be connected to the inlet of the compressor. A low-temperature and low-pressure refrigerant, which is evaporated in the indoor heat exchanger or the outdoor heat exchanger, may flow into the accumulator.

When a refrigerant mixture of refrigerant liquid and refrigerant gas is introduced, the accumulator may separate the refrigerant liquid from the refrigerant gas, and supply the refrigerant gas, from which the refrigerant liquid is separated, to the compressor.

An outdoor fan may be provided near the outdoor heat exchanger. The outdoor fan may blow outdoor air to the outdoor heat exchanger to promote heat exchange between the refrigerant and the outdoor air.

The outdoor unit of the air conditioner may include at least one sensor (hereinafter referred to as an outdoor unit sensor). For example, the sensor of the outdoor unit may be provided as an environment sensor. The outdoor unit sensor may be disposed at a certain position of the inside or the outside of the outdoor unit. For example, the outdoor unit sensor may include a temperature sensor configured to detect an air temperature around the outdoor unit, a humidity sensor configured to detect air humidity around the outdoor unit, or a refrigerant temperature sensor configured to detect a refrigerant temperature in a refrigerant pipe passing through the outdoor unit, or a refrigerant pressure sensor configured to detect a refrigerant pressure in a refrigerant pipe passing through the outdoor unit.

The outdoor unit of the air conditioner may include an outdoor unit communication circuitry. The outdoor unit communication circuitry may be configured to receive a control signal from an indoor unit controller of the air conditioner, which will be described later. Based on a control signal received through the outdoor unit communication circuitry, the outdoor unit may control the operation of the compressor, the outdoor heat exchanger, the expansion device, the flow path switching valve, the accumulator, or the outdoor fan. The outdoor unit may transmit a sensing value detected by the outdoor unit sensor to the indoor unit controller through the outdoor unit communication circuitry.

The outdoor unit communication circuitry may include at least one of a short-range communication module or a long-range communication module.

The indoor unit of the air conditioner may include a housing, a blower configured to circulate air inside or outside the housing, and the indoor heat exchanger configured to exchange heat with air introduced into the housing.

The housing may include an inlet. Indoor air may flow into the housing through the inlet.

The indoor unit of the air conditioner may include a filter provided to filter out foreign substance in air that is introduced into the inside of the housing through the inlet.

The housing may include an outlet. Air flowing inside the housing may be discharged to the outside of the housing through the outlet.

An airflow guide configured to guide a direction of air discharged through the outlet may be provided in the housing of the indoor unit. For example, the airflow guide may include a blade positioned in the outlet. For example, the airflow guide may include an auxiliary fan for regulating an exhaust airflow, but is not limited thereto. Alternatively, the airflow guide may be omitted.

The indoor heat exchanger and the blower arranged on a flow path connecting the inlet and the outlet may be disposed inside the housing of the indoor unit.

The blower may include an indoor fan and a fan motor. For example, the indoor fan may include an axial fan, a mixed flow fan, a crossflow fan and a centrifugal fan.

The indoor heat exchanger may be arranged between the blower and the outlet or between the inlet and the blower. The indoor heat exchanger may absorb heat from air introduced through the inlet or transfer heat to air introduced through the inlet. The indoor heat exchanger may include a heat exchange tube through which a refrigerant flows, and a heat exchanger fin in contact with the heat exchange tube to increase a heat transfer area.

The indoor unit of the air conditioner may include a drain tray disposed below the indoor heat exchanger to collect condensed water generated in the indoor heat exchanger. The condensed water contained in the drain tray may be drained to the outside through a drain hose. The drain tray may be provided to support the indoor heat exchanger.

The indoor unit of the air conditioner may include an input interface. The input interface may include any type of user input means including a button, a switch, a touch screen and/or a touch pad. A user can directly input setting data (e.g., desired indoor temperature, cooling/heating/dehumidifying/air cleaning operation mode setting, outlet selection setting, and/or air volume setting) through the input interface.

The input interface may be connected to an external input device. For example, the input interface may be electrically connected to a wired remote controller. The wired remote controller may be installed at a specific location (e.g., a part of a wall) in an indoor space. A user can input setting data related to the operation of the air conditioner by manipulating the wired remote controller. An electrical signal corresponding to the setting data obtained through the wired remote controller may be transmitted to the input interface. Further, the input interface may include an infrared sensor. A user can remotely input the setting data for the operation of the air conditioner by using a wireless remote controller. The setting data received through the wireless remote controller may be transmitted to the input interface as an infrared signal.

Further, the input interface may include a microphone. A user's voice command may be obtained through the microphone. The microphone may convert a user's voice command into an electrical signal and transmit the electrical signal to the indoor unit controller. The indoor unit controller may control components of the air conditioner to execute a function corresponding to the user's voice command. The setting data obtained through the input interface (e.g., desired indoor temperature, cooling/heating/dehumidifying/air cleaning operation mode setting, outlet selection setting, and/or air volume setting) may be transmitted to the indoor unit controller to be described later. For example, the setting data obtained through the input interface may be transmitted to the outside, that is, to the outdoor unit or a server through an indoor unit communication circuitry to be described later.

The indoor unit of the air conditioner may include a power module. The power module may be connected to an external power source to supply power to components of the indoor unit.

The indoor unit of the air conditioner may include an indoor unit sensor. The indoor unit sensor may be an environment sensor disposed inside or outside the housing. For example, the indoor unit sensor may include one or more temperature sensors and/or humidity sensors disposed in a predetermined space inside or outside the housing of the indoor unit. For example, the indoor unit sensor may include a refrigerant temperature sensor configured to detect a refrigerant temperature of a refrigerant pipe passing through the indoor unit. For example, the indoor unit sensor may include a refrigerant temperature sensor configured to detect a temperature of an entrance, a middle portion and/or an exit of the refrigerant pipe passing through the indoor heat exchanger.

For example, each environmental information detected by the indoor unit sensor may be transmitted to the indoor unit controller to be described later or transmitted to the outside through the indoor unit communication circuitry to be described later.

The indoor unit of the air conditioner may include the indoor unit communication circuitry. The indoor unit communication circuitry may include at least one of a short-range wireless communication module and a long-range wireless communication module. The indoor unit communication circuitry may include at least one antenna for wirelessly communicating with other devices. The outdoor unit may include the outdoor unit communication circuitry. The outdoor unit communication circuitry may also include at least one of a short-range wireless communication module and a long-range wireless communication module.

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server on a mobile communication network.

The indoor unit communication circuitry may communicate with an external device such as a server, a mobile device and other home appliances through an access point (AP). The access point (AP) may connect a local area network (LAN), to which an air conditioner or a user device is connected, to a wide area network (WAN) to which a server is connected. The air conditioner or the user device may be connected to the server through the wide area network (WAN). The indoor unit of the air conditioner may include the indoor unit controller configured to control components of the indoor unit including the blower. The outdoor unit of the air conditioner may include an outdoor unit controller configured to control components of the outdoor unit including the compressor. The indoor unit controller may communicate with the outdoor unit controller through the indoor unit communication circuitry and the outdoor unit communication circuitry. The outdoor unit communication circuitry may transmit a control signal generated by the outdoor unit controller to the indoor unit communication circuitry, or transmit a control signal, which is transmitted from the indoor unit communication circuitry, to the outdoor unit controller. In other words, the outdoor unit and the indoor unit may perform bi-directional communication. The outdoor unit and the indoor unit may transmit and receive various signals generated during operation of the air conditioner.

The outdoor unit controller may be electrically connected to components of the outdoor unit and may control operations of each component. For example, the outdoor unit controller may adjust a frequency of the compressor and control the flow path switching valve to change a circulation direction of the refrigerant. The outdoor unit controller may adjust a rotational speed of the outdoor fan. Further, the outdoor unit controller may generate a control signal for adjusting the opening degree of the expansion valve. Under the control of the outdoor unit controller, the refrigerant may be circulated along the refrigerant circulation circuit including the compressor, the flow path switching valve, the outdoor heat exchanger, the expansion valve, and the indoor heat exchanger.

Various temperature sensors included in the outdoor unit and the indoor unit may transmit electrical signals corresponding to detected temperatures to the outdoor unit controller and/or the indoor unit controller. For example, the humidity sensors included in the outdoor unit and the indoor unit may respectively transmit electrical signals corresponding to the detected humidity to the outdoor unit controller and/or the indoor unit controller.

The indoor unit controller may obtain a user input from a user device including a mobile device through the indoor unit communication circuitry, or directly obtain a user input through the input interface or the remote controller. The indoor unit controller may control components of the indoor unit including the blower in response to the received user input. The indoor unit controller may transmit information related to the received user input to the outdoor unit controller of the outdoor unit.

The outdoor unit controller may control components of the outdoor unit including the compressor based on the information related to the user input received from the indoor unit. For example, when a control signal corresponding to a user input for selecting an operation mode such as a cooling operation, a heating operation, a fan operation, a defrosting operation, or a dehumidifying operation is received from the indoor unit, the outdoor unit controller may control components of the outdoor unit to perform an operation of the air conditioner corresponding to the selected operation mode.

The outdoor unit controller and indoor unit controller may include a processor and a memory, respectively. The indoor unit controller may include at least one first processor and at least one first memory, and the outdoor unit controller may include at least one second processor and at least one second memory.

The memory may memorize/store various types of information necessary for the operation of the air conditioner. The memory may store instructions, applications, data and/or programs necessary for the operation of the air conditioner. For example, the memory may store various programs for the cooling operation, the heating operation, the dehumidifying operation, and/or the defrosting operation of the air conditioner. The memory may include volatile memory such as a static random access memory (S-RAM) and a dynamic random access memory (D-RAM) for temporarily storing data. In addition, the memory may include a non-volatile memory such as a read only memory (ROM), an erasable programmable read only memory (EPROM), and an electrically erasable programmable read only memory (EEPROM) for long-term storage of data.

The processor may generate a control signal for controlling an operation of the air conditioner based on instructions, applications, data, and/or programs stored in the memory. The processor may be hardware and may include a logic circuit and an arithmetic circuit. The processor may process data according to a program and/or instructions provided from the memory, and may generate a control signal according to a processing result. The memory and the processor may be implemented as one control circuit or as a plurality of circuits.

The indoor unit of the air conditioner may include an output interface. The output interface may be electrically connected to the indoor unit controller, and output information related to the operation of the air conditioner under the control of the indoor unit controller. For example, the output interface may output information such as an operation mode selected by a user input, a wind direction, a wind volume, and a temperature. Further, the output interface may output sensing information obtained from the indoor unit sensor or the outdoor unit sensor, and output warning/error messages.

The output interfaces may include a display and a speaker. The speaker may be a sound device and configured to output various sounds. The display may display information, which is input by a user or provided to a user, as various graphic elements. For example, operation information of the air conditioner may be displayed as at least one of an image and text. Further, the display may include an indicator providing specific information. The display may include a liquid crystal display (LCD) panel, a light emitting diode (LED) panel, an organic light emitting diode (OLED) panel, a micro-LED panel, and/or a plurality of LEDs.

Reference will now be made in detail to embodiments of the disclosure, examples of which are illustrated in the accompanying drawings.

Hereinafter for convenience of description, a window-type air conditioner 3 installed on a window and/or a window frame will be described as an example. However, contents of the present disclosure may also be applied to other types of air conditioners. For example, the content of the present disclosure may also be applied to portable air conditioners, wall-mounted air conditioners, ceiling-type air conditioners, and floor-type air conditioners. For example, the content of the present disclosure may also be applied to an indoor unit or outdoor unit of a separate air conditioning system.

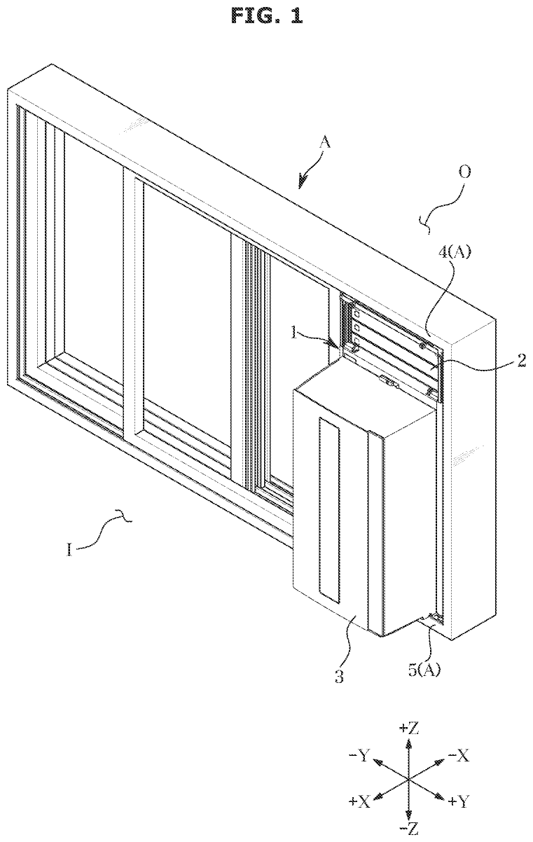

For example, referring to FIG. 1, a direction in which the air conditioner 3 faces an indoor space I may be defined as forward (+X direction), and a direction in which the air conditioner 3 faces an outdoor space O may be defined as rearward (−X direction). For example, a height direction of the air conditioner 3 may be defined as a vertical direction (or up and down direction) (Z direction). However, this is defined based on the drawings, and the shape and location of each component are not limited by the term.

FIG. 1 is a view illustrating an air conditioning apparatus according to an embodiment.

The air conditioning apparatus1 may include a mounting device 2.

The mounting device 2 may be provided to mount the air conditioner 3, which will be described later, to a structure A. The mounting device 2 may be provided to hold the air conditioner 3. The mounting device 2 may allow the air conditioner 3 to be installed in the structure A.

The mounting device 2 may be provided to be mounted on the structure A. The mounting device 2 may be provided to be fixed to the structure A. The mounting device 2 may be provided to be installed on the structure A.

The mounting device 2 may be provided to seal between the air conditioner 3 and the structure A. The mounting device 2 may be arranged to block between the indoor space I and the outdoor space O.

The mounting device 2 may be referred to as a mounting assembly 2, a mounting unit 2, a mounting kit 2, a holder assembly 2, a holder unit 2, a holder kit 2, a holder 2, an installation assembly 2, an installation unit 2, an installation kit 2, or an installation device 2.

For example, the structure A may include a window frame and/or a window. However, the present disclosure is not limited thereto. The structure A may be provided in various ways according to the type of air conditioner 3. For example, the structure A may include at least one of a wall, a ceiling, or a floor. On the drawings, an example in which the structure A is a window frame A is described. Hereinafter for convenience of description, the structure A may be referred to as a window frame A. However, the present disclosure is not limited to the drawings, and it is sufficient for the structure A to include a configuration on which the air conditioner 3 is mounted.

The air conditioning apparatus 1 may include the air conditioner 3.

The air conditioner 3 may be provided to be held on the mounting device 2. The air conditioner 3 may be provided to be mounted on the structure A by being mounted on the mounting device 2. The air conditioner 3 may be installed in the structure A through the mounting device 2.

For example, a portion of the air conditioner 3 may be provided to face a first space (e.g., the indoor space I). For example, another portion of the air conditioner 3 may be provided to face a second space (e.g., the outdoor space O).

The air conditioning apparatus1 may include the air conditioner 3 and the mounting device 2 configured to mount the air conditioner 3 to the structure A.

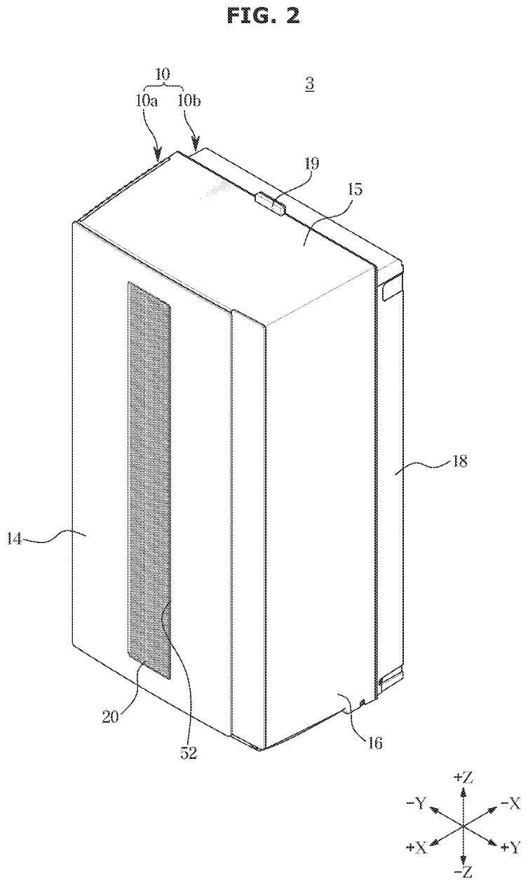

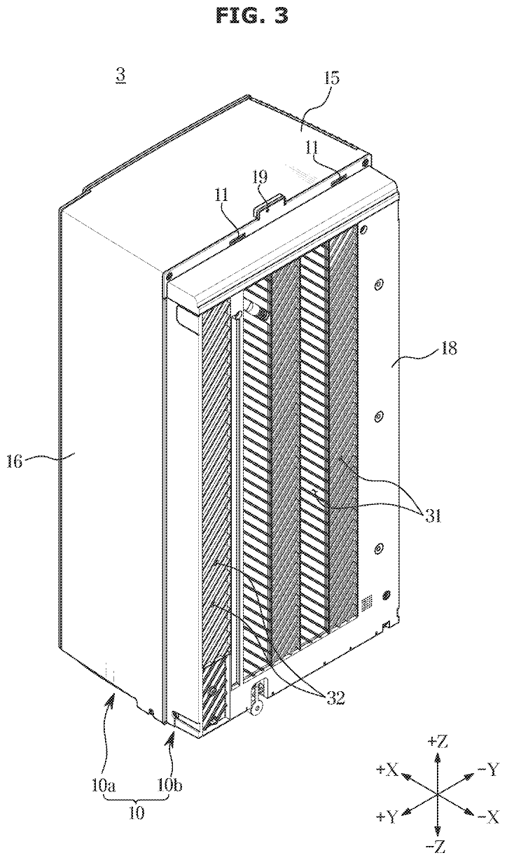

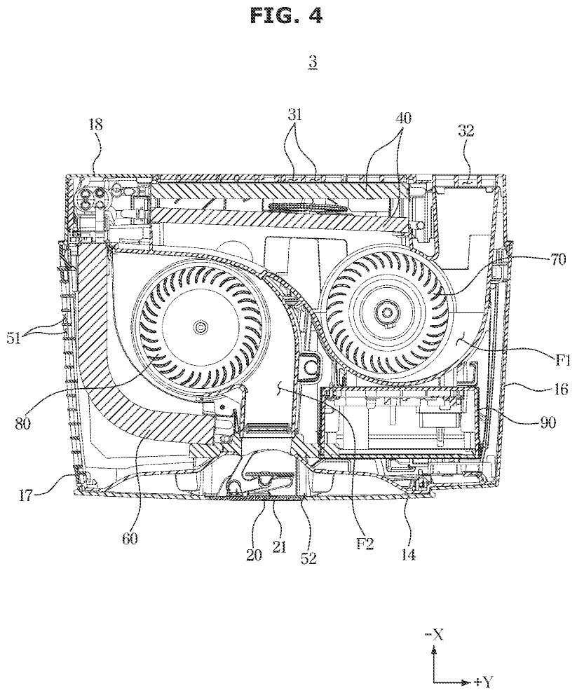

FIG. 2 is a perspective view illustrating an air conditioner according to an embodiment. FIG. 3 is a perspective view illustrating the air conditioner of FIG. 2 when viewed from another direction. FIG. 4 is a planar cross-sectional view of the air conditioner according to an embodiment.

The air conditioner 3 may include a housing 10. The housing 10 may be provided to form an overall appearance of the air conditioner 3. The housing 10 may have a substantially box shape.

For example, the housing 10 may include a front case 10a. For example, the housing 10 may include a rear case 10b. The front case 10a may be provided to be detachably couplable to the rear case 10b.

The front case 10a may be arranged to face the indoor space I (refer to FIG. 1). For example, the front case 10a may be provided to form at least a portion of a front exterior of the air conditioner 3.

The rear case 10b may be arranged to face the outdoor space O (refer to FIG. 1). For example, the rear case 10b may be provided to form at least a portion of a rear exterior of the air conditioner 3.

For example, the housing 10 may include a front panel 14. The front panel 14 may form a front surface of the housing 10.

For example, the housing 10 may include a top panel 15. The top panel 15 may form an upper surface of the air conditioner 3.

For example, the housing 10 may include a first side panel 16. The first side panel 16 may form a right surface of the air conditioner 3.

For example, the housing 10 may include a second side panel 17. The second side panel 17 may form a left surface of the air conditioner 3. The second side panel 17 may be provided on the opposite side of the first side panel 16.

For example, the housing 10 may include a rear panel 18. The rear panel 18 may form a rear surface of the air conditioner 3.

For example, the housing 10 may include a bottom panel. The bottom panel may form a lower surface of the air conditioner 3. The bottom panel may be provided to support at least a part of a configuration disposed inside the air conditioner 3.

For example, the front case 10a may include the front panel 14, the top panel 15, the first side panel 16, and the second side panel 17. For example, the rear case 10b may include the rear panel 18. However, it is not limited thereto, and the front case 10a and the rear case 10b may include various combinations of panels.

The housing 10 may include a first inlet 31 through which outdoor air is introduced. Outdoor air may flow into the housing 10 through the first inlet 31.

The first inlet 31 may be arranged to face the outdoor space O (refer to FIG. 1). The first inlet 31 may be in communication with the outdoor space O. For example, the first inlet 31 may be formed in the rear case 10b to allow outdoor air to be introduced. For example, the first inlet 31 may be formed in the rear panel 18. However, the present disclosure is not limited thereto, and it is sufficient that the first inlet 31 is formed in a portion of the housing 10 facing the outdoor space O.

The housing 10 may include a first outlet 32 through which air that is heat-exchanged with a first heat exchanger 40 is discharged. Outdoor air introduced into the housing 10 through the first inlet 31 may be heat-exchanged with the first heat exchanger 40 and then discharged to the outdoor space O through the first outlet 32.

The first outlet 32 may be arranged to face the outdoor space O (refer to FIG. 1). The first outlet 32 may be in communication with the outdoor space O. For example, the first outlet 32 may be formed in the rear case 10b. For example, the first outlet 32 may be formed in the rear panel 18. However, the present disclosure is not limited thereto, and it is sufficient that the first outlet 32 is formed in a portion of the housing 10 facing the outdoor space O.

The first outlet 32 may be distinguished from the first inlet 31. The first outlet 32 may be formed to be spaced apart from the first inlet 31.

A first flow path F1 (refer to FIG. 4) may be formed inside the housing 10. Outdoor air may flow on the first flow path F1. The first flow path F1 may be formed between the first inlet 31 and the first outlet 32. For example, the first heat exchanger 40 may be provided on the first flow path F1. For example, a first fan 70 may be arranged on the first flow path F1.

The housing 10 may include a second inlet 51 through which indoor air is introduced. Indoor air may flow into the housing 10 through the second inlet 51.

The second inlet 51 may be arranged to face the indoor space I (refer to FIG. 1). The second inlet 51 may be in communication with the indoor space I. For example, the second inlet 51 may be formed in the front case 10a to allow indoor air to be introduced. For example, the second inlet 51 may be formed in the second side panel 17. However, the present disclosure is not limited thereto, and it is sufficient that the second inlet 51 is formed in a portion of the housing 10 facing the indoor space I.

The housing 10 may include a second outlet 52 through which air that is heat-exchanged with a second heat exchanger 60 is discharged. The indoor air introduced into the housing 10 through the second inlet 51 may be heat-exchanged with the second heat exchanger 60 and then discharged to the outdoor space O through the second outlet 52.

The second outlet 52 may be arranged to face the indoor space I (refer to FIG. 1). The second outlet 52 may be in communication with the indoor space I. For example, the second outlet 52 may be formed in the front case 10a. For example, the second outlet 52 may be formed in the front panel 14. However, the present disclosure is not limited thereto, and it is sufficient that the second outlet 52 is formed in a portion of the housing 10 facing the indoor space I.

The second outlet 52 may be distinguished from the second inlet 51. The second outlet 52 may be formed to be spaced apart from the second inlet 51.

A second flow path F2 may be formed inside the housing 10. Indoor air may flow on the second flow path F2. The second flow path F2 may be formed between the second inlet 51 and the second outlet 52. For example, the second heat exchanger 60 may be provided on the second flow path F2. For example, a second fan 80 may be provided on the second flow path F2.

The first flow path F1 and the second flow path F2 may be arranged to be partitioned from each other. Outdoor air flowing through the first flow path F1 and indoor air flowing through the second flow path F2 may not mix inside the housing 10.

The air conditioner 3 may include a blade 20. The blade 20 may be provided to guide indoor air discharged through the second outlet 52. The blade 20 may be configured to adjust a discharge direction of air that is discharged into the indoor space through the second outlet 52.

The blade 20 may be configured to open or cover the second outlet 52. The blade 20 may have a shape that corresponds to the second outlet 52.

The blade 20 may be detachably coupled to the housing 10. The blade 20 may be rotatably coupled to the housing 10. For example, the blade 20 may be rotatably coupled to the front panel 14.

For example, the blade 20 may include a plurality of discharge holes 21. For example, in a state in which the blade 20 covers the second outlet 52, indoor air passing through the second heat exchanger 60 may be discharged through the plurality of discharge holes 21.

The air conditioner 3 may include the first heat exchanger 40. The first heat exchanger 40 may be configured to exchange heat with outdoor air introduced through the first inlet 31. The first heat exchanger 40 may be disposed inside the housing 10. The first heat exchanger 40 may be disposed on the first flow path F1. The first heat exchanger 40 may be arranged to face the first inlet 31.

The air conditioner 3 may include the second heat exchanger 60. The second heat exchanger 60 may be configured to exchange heat with indoor air introduced through the second inlet 51. The second heat exchanger 60 may be disposed inside the housing 10. The second heat exchanger 60 may be disposed on the second flow path F2. At least a portion of the second heat exchanger 60 may be arranged to face the second inlet 51. For example, the second heat exchanger 60 may be arranged to surround at least a portion of the second fan 80.

For example, the first heat exchanger 40 may be provided as a condenser, and the second heat exchanger 60 may be provided as an evaporator. At this time, the air conditioner 3 may be configured to cool the indoor space. However, the present disclosure is not limited thereto. Alternatively, the first heat exchanger 40 may be provided as an evaporator, and the second heat exchanger 60 may be provided as a condenser. At this time, the air conditioner 3 may be configured to heat the indoor space.

The air conditioner 3 may include the first fan 70. The first fan 70 may generate a blowing force. The first fan 70 may be configured to blow outdoor air. The first fan 70 may be configured to move outdoor air within the housing 10. The first fan 70 may be configured to move outdoor air between the first inlet 31 and the first outlet 32. The first fan 70 may be arranged to face at least a portion of the first heat exchanger 40.

The air conditioner 3 may include the second fan 80. The second fan 80 may generate a blowing force. The second fan 80 may be configured to blow indoor air. The second fan 80 may be configured to move indoor air within the housing 10. The second fan 80 may be configured to move indoor air between the second inlet 51 and the second outlet 52. The second fan 80 may be arranged to face at least a portion of the second heat exchanger 60.

The air conditioner 3 may include a control box 90. The control box 90 may include a circuit board. The control box 90 may include various electronic components. The control box 90 may be configured to control an operation of the air conditioner 3. For example, the control box 90 may be disposed between the front panel 14 and the first fan 70.

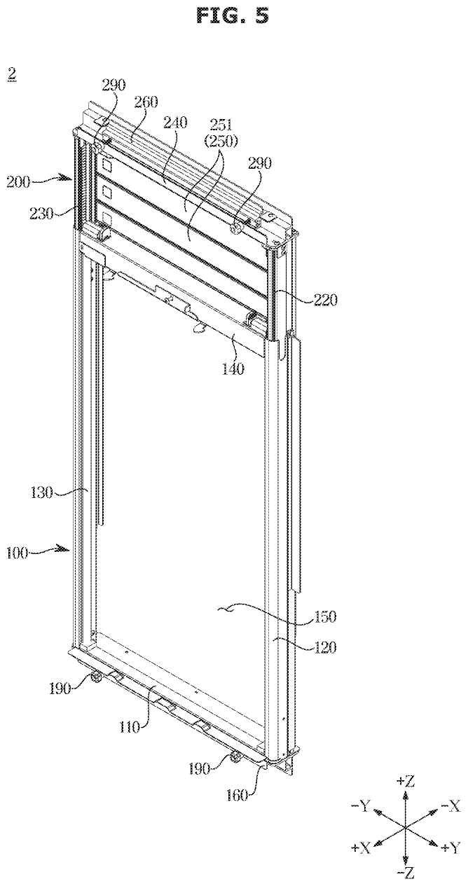

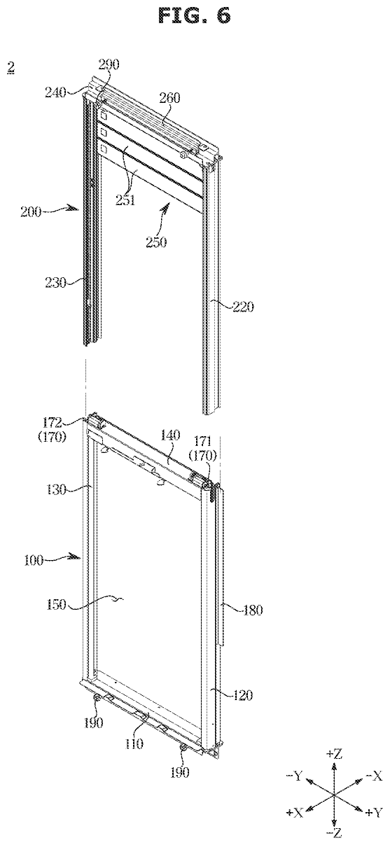

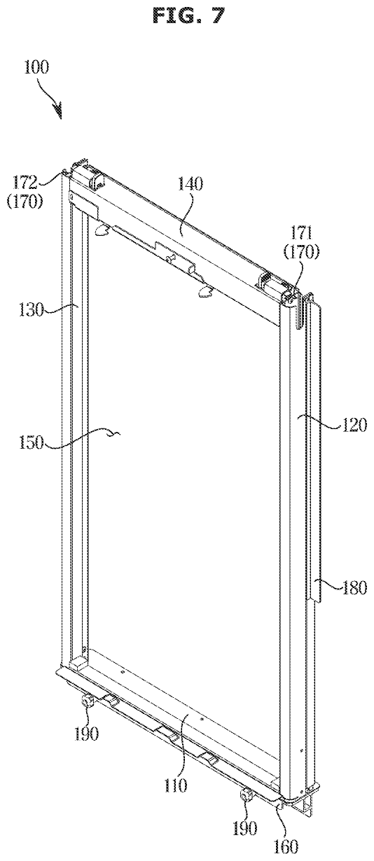

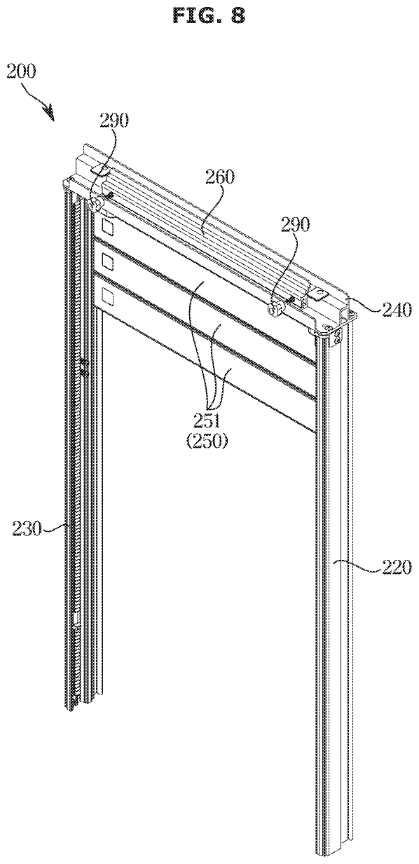

FIG. 5 is a perspective view of a mounting device according to an embodiment. FIG. 6 is an exploded view of the mounting device according to an embodiment. FIG. 7 is a perspective view of a fixing frame according to an embodiment. FIG. 8 is a perspective view of a moving frame according to an embodiment.

The mounting device 2 may include a frame configured to be mountable on the structure A.

For example, the mounting device 2 may include a fixing frame 100. For example, the mounting device 2 may include a moving frame 200. For example, the frame may include the fixing frame 100 and/or the moving frame 200. However, unlike the drawings, the frame may be provided as a single configuration.

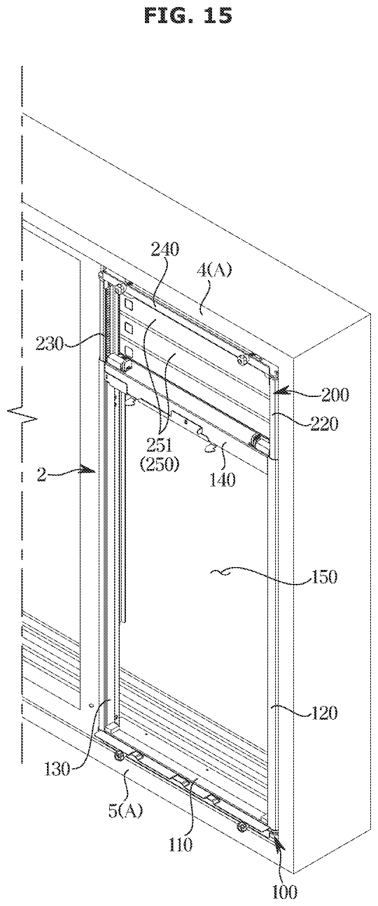

The fixing frame 100 may be mounted on the structure A (refer to FIG. 15). The fixing frame 100 may be fixed to the structure A. The fixing frame 100 may be provided to be fixed to a lower portion 5 of the structure A.

The fixing frame 100 may be provided to hold the air conditioner 3. The fixing frame 100 may be provided to hold the housing 10 of the air conditioner 3. For example, when the air conditioner 3 is mounted on the mounting device 2, the fixing frame 100 may be provided to surround the housing 10 of the air conditioner 3. For example, the fixing frame 100 may have a shape corresponding to the housing 10 of the air conditioner 3. For example, the fixing frame 100 may have a substantially rectangular shape.

The fixing frame 100 may include a first frame portion 110 fixed to the lower portion 5 of the structure A. The first frame portion 110 may be mounted on the lower portion 5 of the structure A. The first frame portion 110 may be supported by the lower portion 5 of the structure A. The first frame portion 110 may support the lower surface of the air conditioner 3. The first frame portion 110 may have a shape extending along a substantially horizontal direction (Y direction). The first frame portion 110 of the fixing frame 100 may be referred to as a lower frame portion 110 of the fixing frame 100.

The fixing frame 100 may include a second frame portion 120. The second frame portion 120 may extend upward from one side of the first frame portion 110. The second frame portion 120 may have a shape extending along a substantially vertical direction (Z direction). The second frame portion 120 may be provided to be in contact with the first side panel 16 of the air conditioner 3. The second frame portion 120 of the fixing frame 100 may be referred to as a first side frame portion 120 of the fixing frame 100.

The fixing frame 100 may include a third frame portion 130. The third frame portion 130 may extend from the other side of the first frame portion 110 to be parallel to the second frame portion 120. The third frame portion 130 may extend upward from the other side of the first frame portion 110. The third frame portion 130 may have a shape extending along the substantially vertical direction (Z direction). The third frame portion 130 may be provided to be in contact with the second side panel 17 of the air conditioner 3. The third frame portion 130 of the fixing frame 100 may be referred to as a second side frame portion 130 of the fixing frame 100.

The fixing frame 100 may include a fourth frame portion 140. The fourth frame portion 140 may connect the second frame portion 120 and the third frame portion 130. The fourth frame portion 140 may connect an upper end of the second frame portion 120 and an upper end of the third frame portion 130. The fourth frame portion 140 may have a shape extending in the substantially horizontal direction (Y direction). The fourth frame portion 140 may be provided to be in contact with the top panel 15. The fourth frame portion 140 of the fixing frame 100 may be referred to as an upper frame portion 140 of the fixing frame 100.

The fixing frame 100 may include a mounting opening 150. The air conditioner 3 may be mounted on the fixing frame 100 through the mounting opening 150. The housing 10 of the air conditioner 3 may be placed in the mounting opening 150. The mounting opening 150 may be formed by the first frame portion 110, the second frame portion 120, the third frame portion 130, and the fourth frame 140. The mounting opening 150 may be defined by the first frame portion 110, the second frame portion 120, the third frame portion 130, and the fourth frame portion 140.

The fixing frame 100 may include a lower fixing bracket 160. The lower fixing bracket 160 may be provided on the first frame portion 110. The lower fixing bracket 160 may be provided to be in contact with the lower portion 5 of the structure A. For example, a first fastening member 190 may allow the lower portion 5 of the structure A and the lower fixing bracket 160 to close contact with each other.

The fixing frame 100 may include a lifting and lowering guide 170 for guiding the up and down movement of the moving frame 200. The lifting and lowering guide 170 may include a first moving rail 171 formed on the second frame portion 120. The first moving rail 171 may extend along an extension direction of the second frame portion 120. The first moving rail 171 may extend along the substantially vertical direction (Z direction). The lifting and lowering guide 170 may include a second moving rail 172 formed on the third frame portion 130. The second moving rail 172 may extend along an extension direction of the third frame portion 130. The second moving rail 172 may extend along the substantially vertical direction (Z direction).

The fixing frame 100 may include a fixed panel 180. The fixed panel 180 may be disposed adjacent to the structure A to prevent the mounting device 2 from falling. On the drawing, it is illustrated that the fixed panel 180 is formed on the second frame portion 120, but is not limited thereto. Alternatively, the fixed panel 180 may be formed in the third frame portion 130. Alternatively, the fixed panel 180 may be formed in the second frame portion 120 and the third frame portion 130.

The moving frame 200 may be mounted on the structure A (refer to FIG. 15). The moving frame 200 may be fixed to the structure A. The moving frame 200 may be provided to be fixed to an upper portion 4 of the structure A.

The moving frame 200 may be configured to move up and down with respect to the fixing frame 100. The moving frame 200 may be configured to perform the lifting and lowering movement with respect to the fixing frame 100. The moving frame 200 may be configured to move relative to the fixing frame 100. The moving frame 200 may be configured to move along the substantially vertical direction (Z direction). The moving frame 200 may be configured to be withdrawn from the fixing frame 100. The moving frame 200 may be configured to be inserted into the fixing frame 100.

For example, the fixing frame 100 may be fixed to the lower portion 5 of the window frame, and the moving frame 200 may move up and down with respect to the fixing frame 100 and then be fixed to the upper portion 4 of the window frame. That is, the moving frame 200 may be configured to move up and down in accordance with the shape and/or size of the structure A.

The moving frame 200 may include a fifth frame portion 220. The fifth frame portion 220 may extend along a moving direction of the moving frame 200. The fifth frame portion 220 may be configured to move relative to the second frame portion 120 of the fixing frame 100. The fifth frame portion 220 may be configured to move up and down with respect to the second frame portion 120 of the fixing frame 100. The fifth frame portion 220 may be configured to move along the first moving rail 171 formed in the second frame portion 120. The fifth frame portion 220 may be configured to slide along the first moving rail 171. The fifth frame portion 220 may be configured to be withdrawn from and inserted into the first moving rail 171. The fifth frame portion 220 of the moving frame 200 may be referred to as a first side frame portion 220 of the moving frame 200.

The moving frame 200 may include a sixth frame portion 230. The sixth frame portion 230 may extend along the moving direction of the moving frame 200. The sixth frame portion 230 may extend parallel to the fifth frame portion 220. The sixth frame portion 230 may be configured to move relative to the third frame portion 130 of the fixing frame 100. The sixth frame portion 230 may be configured to move up and down with respect to the third frame portion 130 of the fixing frame 100. The sixth frame portion 230 may be configured to move along the second moving rail 172 formed in the third frame portion 130. The sixth frame portion 230 may be configured to slide along the second moving rail 172. The sixth frame portion 230 may be configured to be withdrawn from and inserted into the second moving rail 172. The sixth frame portion 230 of the moving frame 200 may be referred to as a second side frame portion 230 of the moving frame 200.

The moving frame 200 may include a seventh frame portion 240. The seventh frame portion 240 may be provided to be fixed to the upper portion 4 of the structure A. The seventh frame portion 240 may connect the fifth frame portion 220 and the sixth frame portion 230. The seventh frame portion 240 may be provided to connect an upper end of the fifth frame portion 220 and an upper end of the sixth frame portion 230. The seventh frame portion 240 may have a shape extending in the substantially horizontal direction (Y direction). The seventh frame portion 240 of the moving frame 200 may be referred to as an upper frame portion 240 of the moving frame 200.

The moving frame 200 may include a screen 250. The screen 250 may cover a region surrounded by the fixing frame 100, the fifth frame portion 220, the sixth frame portion 230, and the seventh frame portion 240. The screen 250 may be provided to accommodate an indicating panel 330, which will be described later.

The screen 250 may be provided to cover a space between the air conditioner 3 and the structure A. For example, the screen 250 may be provided to block the indoor space I and the outdoor space O (refer to FIG. 1).

For example, the screen 250 may include a plurality of cover panels 251. The plurality of cover panels 251 may be arranged along the moving direction of the moving frame 200. The plurality of cover panels 251 may be arranged along the substantially vertical direction (Z direction). For example, two adjacent panels among the plurality of cover panels 251 may be separably coupled to each other. The plurality of cover panels 251 may be provided in various numbers according to the shape and/or size of the structure A. Unlike the drawing, the screen 250 may include a single cover panel 251.

The moving frame 200 may include an upper fixing bracket 260. The upper fixing bracket 260 may be provided on the seventh frame portion 240. The upper fixing bracket 260 may be provided to be in contact with the upper portion 4 of the structure A. For example, a second fastening member 290 may allow the upper portion 4 of the structure A and the upper fixing bracket 260 to close contact with each other.

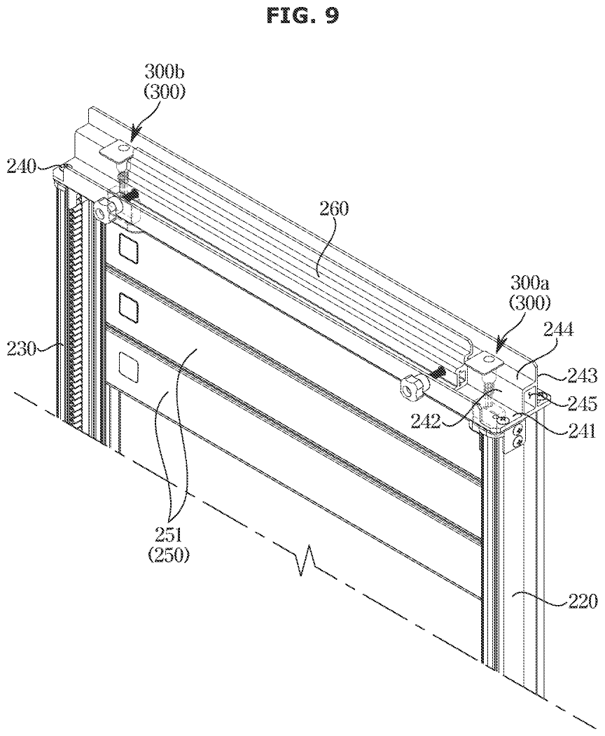

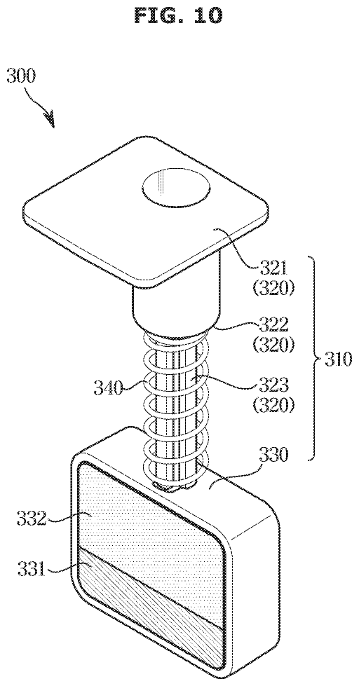

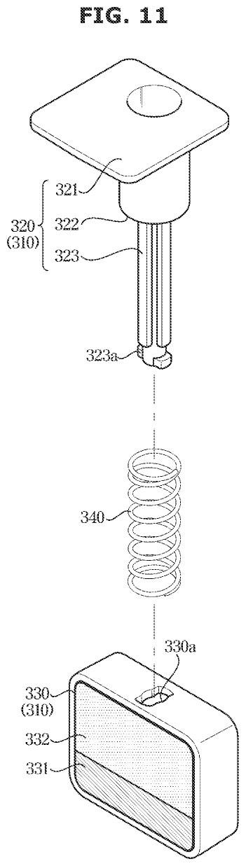

FIG. 9 is a partially enlarged view of the moving frame according to an embodiment. FIG. 10 is a perspective view of a first indicator according to an embodiment. FIG. 11 is an exploded view of the first indicator according to an embodiment.

The mounting device 2 may include a first indicator 300. The first indicator 300 may be configured to indicate whether the mounting device 2 is mounted on the structure A. For example, a user or the like can visually check whether the mounting device 2 is properly assembled to the structure A through the first indicator 300.

For example, the first indicator 300 may be provided on the moving frame 200 and may be in contact with the upper portion 4 of the structure A (refer to FIGS. 15 to 17). At this time, the first indicator 300 may be configured to indicate whether the moving frame 200 is properly fixed to the upper portion 4 of the structure A.

The first indicator 300 may include a moving member 310. The moving member 310 may protrude from the frame. The moving member 310 may protrude from the moving frame 200. The moving member 310 may be movable by being pressed by or against the upper portion 4 of the structure A.

For example, when the moving frame 200 moves up and down with respect to the fixing frame 100 and is fixed to the upper portion 4 of the structure A, the moving member 310 may be pressed by or against the upper portion 4 of the structure A. For example, the moving member 310 may be pressed downward via contact with the upper portion 4 of the structure A.

For example, the moving member 310 may be configured to move along the moving direction of the moving frame 200. For example, the moving member 310 may be provided to move along the substantially vertical direction (Z direction).

For example, the moving member 310 may include a first indicating portion 331 and a second indicating portion 332, which will be described later. A detailed description thereof will be provided later.

The first indicator 300 may include a push member 320. The push member 320 may be provided as a component of the moving member 310. The moving member 310 may include the push member 320. The push member 320 may be arranged adjacent to the upper portion 4 of the structure A and pressed by or against the upper portion 4 of the structure A.

For example, the push member 320 may include a contact portion 321. The contact portion 321 may be exposed to the outside of the moving frame 200. The contact portion 321 may be provided to be in contact with the structure A. The contact portion 321 may be provided to be in contact with the upper portion 4 of the structure A.

For example, the push member 320 may include a stepped portion 322. The stepped portion 322 may be provided to press a first spring 340, which will be described later. The stepped portion 322 may be provided to form a step difference with the contact portion 321. The stepped portion 322 may be provided to form a step difference with a connection portion 323, which will be described later. The stepped portion 322 may protrude to the outside of the moving frame 200 or may be accommodated inside the moving frame 200 as the push member 320 is pressed by or against the structure A.

For example, the push member 320 may include the connection portion 323. The connection portion 323 may be provided to connect the contact portion 321 and an indicating panel 330. The connection portion 323 may be provided to connect the stepped portion 322 and the indicating panel 330. The connection portion 323 may extend from the stepped portion 322. The connection portion 323 may extend downward from the stepped portion 322. The connection portion 323 may be detachably coupled to the indicating panel 330. The connection portion 323 may be accommodated inside the moving frame 200.

The first indicator 300 may include the indicating panel 330. The indicating panel 330 may be provided as a component of the moving member 310. The moving member 310 may include the indicating panel 330. The indicating panel 330 may be arranged to move together with the push member 320 as the push member 320 is pressed. The indicating panel 330 may be configured to move in conjunction with the push member 320.

The indicating panel 330 may be coupled to one end of the push member 320. For example, the indicating panel 330 may be coupled to a lower end of the push member 320. For example, the indicating panel 330 may be detachably coupled to the connection portion 323. For example, the connection portion 323 may include a first coupler 323a, and the indicating panel 330 may include a second coupler 330a provided to be coupled to the first coupler 323a. For example, the first coupler 323a may include a coupling protrusion 323a, and the second coupler 330a may include a coupling groove 330a. However, unlike the drawing, the first coupler 323a may include a coupling groove, and the second coupler 330a may include a coupling protrusion. However, the present disclosure is not limited thereto, and the indicating panel 330 may be formed integrally with the push member 320.

The indicating panel 330 may be spaced apart from the contact portion 321. The indicating panel 330 may be downwardly away from the contact portion 321.

For example, the indicating panel 330 may include the first indicating portion 331 and the second indicating portion 332.

The first indicator 300 may include the first indicating portion 331. The first indicating portion 331 may be provided to be visible from the outside of the moving frame 200 when the moving frame 200 is not fixed to the upper portion 4 of the structure A.

The first indicator 300 may include the second indicating portion 332 distinct from the first indicating portion 331. The second indicating portion 332 may be provided to be visible from the outside of the moving frame 200 when the moving frame 200 is fixed to the upper portion 4 of the structure A.

For example, the first indicating portion 331 and the second indicating portion 332 may be arranged along the moving direction of the moving frame 200. For example, the second indicating portion 332 and the first indicating portion 331 may be arranged along the direction in which the moving member 310 is pressed by or against the structure A. For example, the first indicating portion 331 and the second indicating portion 332 may be arranged along the substantially vertical direction (Z direction). For example, the first indicating portion 331 may be located below the second indicating portion 332. For example, the second indicating portion 332 may be located above the first indicating portion 331.

The first indicating portion 331 and the second indicating portion 332 may be distinguished from each other. For example, the first indicating portion 331 may include a first color, and the second indicating portion 332 may include a second color different from the first color. Alternatively, the first indicating portion 331 may include a first pattern, and the second indicating portion 332 may include a second pattern different from the first pattern. Alternatively, the first indicating portion 331 may include a first symbol, and the second indicating portion 332 may include a second symbol different from the first symbol. Alternatively, the first indicating portion 331 may include a first texture, and the second indicating portion 332 may include a second texture different from the first texture. The present disclosure is not limited to the above-described examples, and it is sufficient that the first indicating portion 331 and the second indicating portion 332 are identified as being different from each other.

The first indicator 300 may include the first spring 340. The first spring 340 may be configured to elastically bias the moving member 310. The first spring 340 may be configured to elastically bias the moving member 310 toward the structure A. For example, the first spring 340 may be configured to elastically bias the moving member 310 toward the upper portion 4 of the structure A. The first indicator 300 may be in close contact with the permanent structure A by the elastic restoring force of the first spring 340.

The first spring 340 may be provided to surround a portion of the moving member 310. For example, the first spring 340 may be provided to surround a portion of the push member 320. For example, the first spring 340 may be provided to surround at least a portion of the connection portion 323. For example, the first spring 340 may be disposed between the stepped portion 322 and the indicating panel 330. For example, the first spring 340 may be pressed by the stepped portion 322.

For example, referring to FIG. 9, a plurality of first indicators 300 may be provided. For example, the plurality of first indicators 300 may be arranged to be spaced apart along the substantially horizontal direction (Y direction). For example, the mounting device 2 may include a first-a indicator 300a provided on the right side of the moving frame 200 and a first-b indicator 300b provided on the left side of the moving frame 200. The first-a indicator 300a may indicate whether the right portion of the moving frame 200 is properly fixed to the structure A. The first-b indicator 300b may indicate whether the left portion of the moving frame 200 is properly fixed to the structure A. A user or the like can check whether the mounting device 2 is level by comparing the indication of the first-a indicator 300a and the indication of the first-b indicator 300b. For example, when the indication of the first-a indicator 300a and the indication of the first-b indicator 300b are different, a user or the like can easily confirm that the mounting device 2 is not level with the structure A. However, unlike shown in FIG. 9, the single first indicator 300 may be provided. Alternatively, unlike shown in FIG. 9, three or more first indicators 300 may be provided.

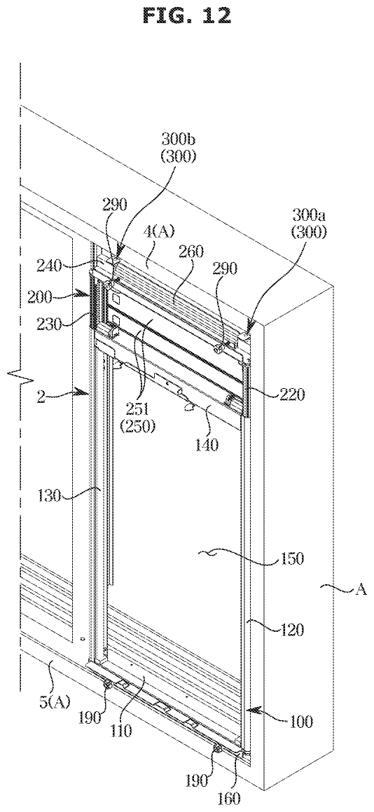

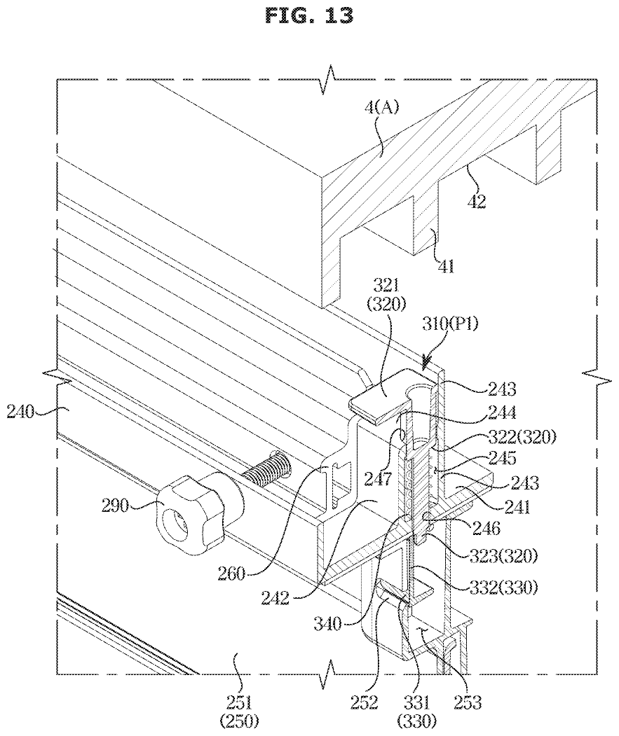

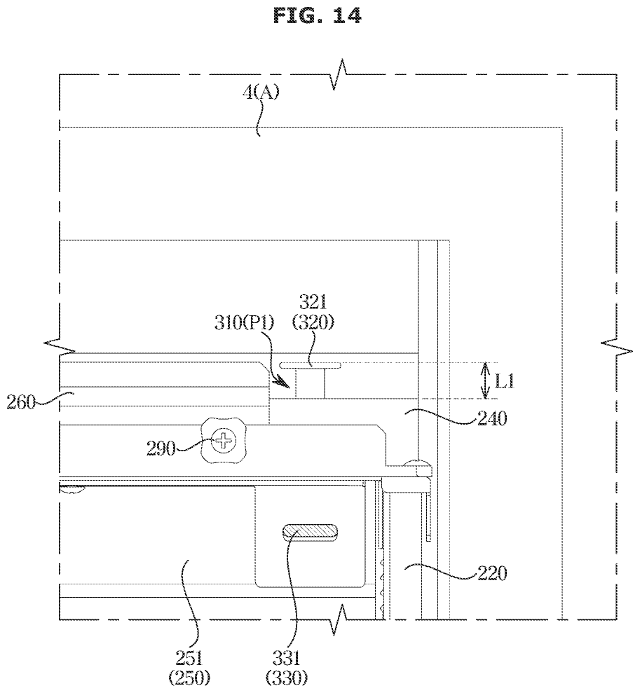

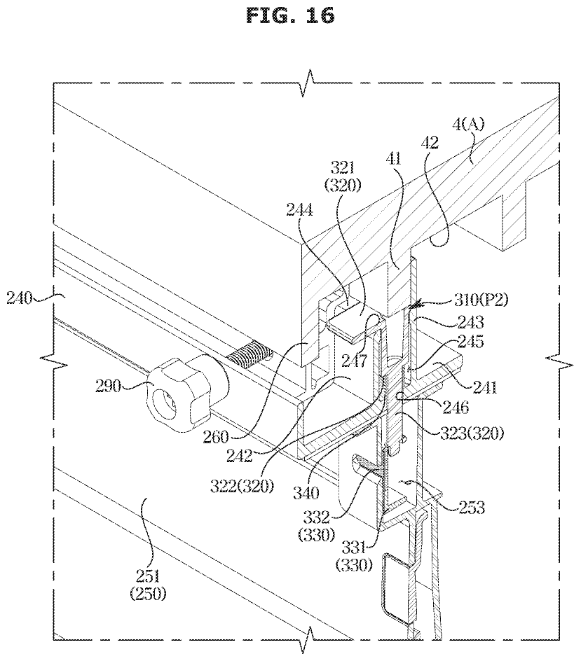

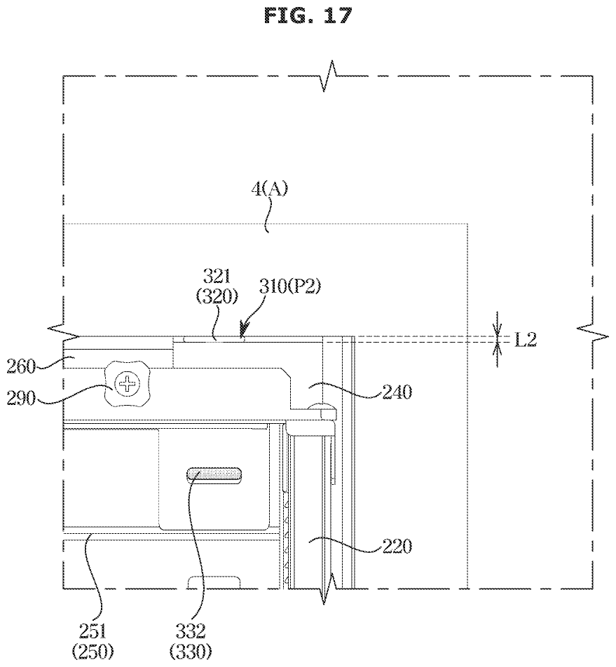

FIG. 12 is a view illustrating an example in which the mounting device is not fixed to a structure. FIG. 13 is a view schematically illustrating a portion of a side cross-section of the state shown in FIG. 12. FIG. 14 is a view schematically illustrating a portion of a front surface of the state shown in FIG. 12. FIG. 15 is a view illustrating an example in which the mounting device is fixed to the structure. FIG. 16 is a view schematically illustrating a portion of a side cross-section of the state shown in FIG. 15. FIG. 17 is a view schematically illustrating a portion of a front surface of the state shown in FIG. 15.

The mounting device 2 may be mounted on the structure A. For example, the fixing frame 100 may be fixed to the lower portion 5 of the structure A, and the moving frame 200 may be fixed to the upper portion 4 of the structure A. For example, after the fixing frame 100 is first fixed to the lower portion 5 of the structure A, the moving frame 200 may be fixed to the upper portion 4 of the structure A by moving up and down with respect to the fixing frame 100.

For example, the upper portion 4 of the structure A may include a protrusion 41 and a groove 42. For example, the window may be configured to slide by being coupled to the protrusion 41 and/or the groove 42.

For example, the seventh frame portion 240 of the moving frame 200 may be provided to accommodate a portion of the first indicator 300.

For example, the seventh frame portion 240 may include a spring accommodating portion 245 for accommodating the first spring 340. For example, the seventh frame portion 240 may include a first plate 241, a second plate 242 extending upward from the first plate 241, a third plate 243 spaced apart from the second plate 242 and extending upward from the first plate 241, and a fourth plate 244 connecting the second plate 242 and the third plate 243. For example, the spring accommodating portion 245 may be formed by the first plate 241, the second plate 242, the third plate 243, and the fourth plate 244. However, the present disclosure is not limited thereto, and the spring accommodating portion 245 may be formed by various shapes of the seventh frame portion 240.

For example, the seventh frame portion 240 may include a first through hole 246 penetrating the first plate 241. For example, at least a portion of the moving member 310 may be movable within the first through hole 246. For example, the connection portion 323 may be movable within the first through hole 246.

For example, the seventh frame portion 240 may include a second through hole 247 penetrating the fourth plate 244. For example, at least a portion of the moving member 310 may be movable within the second through hole 247. For example, the stepped portion 322 may be movable within the second through hole 247.

For example, a size of the contact portion 321 may be greater than a size of the second through hole 247. Even when the moving member 310 is pressed by or against the upper portion 4 of the structure A, the contact portion 321 may not pass through the second through hole 247. When the moving member 310 is pressed by or against the upper portion 4 of the structure A, the contact portion 321 may be in contact with the fourth plate 244. As a result, the downward movement of the moving member 310 may be restricted.

For example, the screen 250 may include a panel accommodating portion 253 for accommodating the indicating panel 330. The panel accommodating portion 253 may be provided to communicate with the spring accommodating portion 245. The panel accommodating portion 253 may be located below the spring accommodating portion 245.

For example, mounting device 2 may include a first opening 252. The moving frame 200 may include the first opening 252. The first opening 252 may be formed in the screen 250. The screen 250 may include the first opening 252. The first opening 252 may be provided to expose at least one of the first indicating portion 331 or the second indicating portion 332 to the outside of the screen 250. The first opening 252 may be provided to expose at least one of the first indicating portion 331 or the second indicating portion 332 to the front of the screen 250. The first opening 252 may be formed to correspond to a portion of the indicating panel 330. The first opening 252 may communicate with the panel accommodating portion 253.

Referring to FIGS. 12 to 17, the moving member 310 may be configured to move between a first position P1 and a second position P2. The moving member 310 may be configured to move between the first position P1 (refer to FIGS. 12 to 14) and the second position P2 (refer to FIGS. 15 to 17) pressed from the first position P1 by the structure A.

Referring to FIGS. 12 to 14, when the mounting device 2 is not fixed to the structure A, the moving member 310 may be in the first position P1.

For example, when the moving frame 200 is not fixed to the upper portion 4 of the structure A, the moving member 310 may be arranged in the first position P1. For example, when the moving frame 200 is not pressed by or against the upper portion 4 of the structure A, the moving member 310 may be arranged in the first position P1.

When the mounting device 2 is not mounted on the structure A, the first indicating portion 331 of the first indicator 300 may be visible from the outside of the mounting device 2.

For example, when the moving frame 200 is not fixed to the upper portion 4 of the structure A, the first indicating portion 331 of the first indicator 300 may be visible from the outside of the moving frame 200. For example, when the moving member 310 is in the first position P1, the first indicating portion 331 may be exposed to the outside of the moving frame 200. For example, when the moving member 310 is in the first position P1, the first indicating portion 331 may be exposed to the front of the mounting device 2. For example, when the moving member 310 is in the first position P1, the first indicating portion 331 may be exposed to the outside of the screen 250 through the first opening 252.

When the first indicating portion 331 of the first indicator 300 is visible from the outside of the moving frame 200, the mounting device 2 may not be properly mounted on the structure A. For example, when the first indicating portion 331 of the first indicator 300 is visible from the outside of the moving frame 200, a user or the like may determine that the moving frame 200 is not properly fixed to the upper portion 4 of the structure A.

Referring to FIGS. 15 to 17, when the mounting device 2 is fixed to the structure A, the moving member 310 may be in the second position P2.

For example, when the moving frame 200 is fixed to the upper portion 4 of the structure A, the moving member 310 may be arranged in the second position P2. For example, when the moving frame 200 is maximally pressed by or against the upper portion 4 of the structure A, the moving member 310 may be arranged in the second position P2.

When the mounting device 2 is mounted on the structure A, the second indicating portion 332 of the first indicator 300 may be visible from the outside of the mounting device 2.

For example, when the moving frame 200 is fixed to the upper portion 4 of the structure A, the second indicating portion 332 of the first indicator 300 may be visible from the outside of the moving frame 200. For example, when the moving member 310 is in the second position P2, the second indicating portion 332 may be exposed to the outside of the moving frame 200. For example, when the moving member 310 is in the second position P2, the second indicating portion 332 may be exposed to the front of the mounting device 2. For example, when the moving member 310 is in the second position P2, the second indicating portion 332 may be exposed to the outside of the screen 250 through the first opening 252.

When the second indicating portion 332 of the first indicator 300 is visible from the outside of the moving frame 200, the mounting device 2 may be properly mounted on the structure A. For example, when the second indicating portion 332 of the first indicator 300 is visible from the outside of the moving frame 200, a user or the like may determine that the moving frame 200 is properly fixed to the upper portion 4 of the structure A.

Referring to FIGS. 12 to 17, according to the extent to which the first indicator 300 is pressed by or against the structure A, a length at which the moving member 310 protrudes from the moving frame 200 may vary. For example, when the moving member 310 is in the first position P1, the moving member 310 may maximally protrude from the moving frame 200. For example, when the moving member 310 is in the second position P2, the moving member 310 may be pressed from the first position P1 by the upper portion 4 of the structure A. For example, when the moving member 310 is in the second position P2, the moving member 310 may protrude minimally from the moving frame 200. For example, a length L1 (refer to FIG. 14) at which the moving member 310 protrudes from the moving frame 200 when the moving member 310 is in the first position P1, may be greater than a length L2 (refer to FIG. 17) at which the moving member 310 protrudes from the moving frame 200 when the moving member 310 is in the second position P2.

As the first indicator 300 is pressed by or against the upper portion 4 of the structure A, the first indicator 300 may be configured to allow the first indicating portion 331 to be switched to the second indicating portion 332 so as to allow the second indicating portion 332 to be visible from the outside of the moving frame 200. For example, a user or the like can determine that the mounting device 2 is mounted on the structure A by confirming that the first indicating portion 331 is switched to the second indicating portion 332. For example, conversely, a user or the like can determine that the mounting device 2 is separated from the structure A by confirming that the second indicating portion 332 is switched to the first indicating portion 331. For example, when both the first indicating portion 331 and the second indicating portion 332 are visible from the outside of the moving frame 200, a user or the like can determine that the mounting device 2 is not properly fixed to the structure A. For example, when both the first indicating portion 331 and the second indicating portion 332 are visible from the outside of the moving frame 200, a user or the like can determine that the moving frame 200 is less pressed by or against the structure A. For example, when both the first indicating portion 331 and the second indicating portion 332 are visible from the outside of the moving frame 200, a user or the like can recognize that it is required for the moving frame 200 to be closer contact with the structure A.

In general, it is important to mount the mounting device to the structure. For example, when the mounting device is not properly mounted on the structure, the air conditioner may not be mounted stably on the mounting device. For example, the air conditioner may be damaged by falling from the mounting device. For example, when the mounting device is not properly mounted on the structure, the blocking between the first space (e.g., indoor space) and the second space (e.g., outdoor space) may not be complete, and the performance of the air conditioner may be reduced. However, it may not be easy to check whether the mounting device is properly installed on the structure. For example, criteria for determining whether the mounting device is installed may not be intuitive. For example, it is not possible to immediately check whether the mounting device is properly fixed to the structure, from the front of the mounting device. For example, because the space between the mounting device and the structure is small, it is difficult to check whether the mounting device is properly fixed to the structure even from the side of the mounting device. Therefore, there is a limit to checking for defective installation of the mounting device.

However, according to the present disclosure, it is possible to easily check whether the mounting device is properly mounted on the structure. For example, the indication of the first indicator 300 may vary depending on whether the mounting device is properly installed in the structure. For example, when the mounting device 2 is not properly fixed to the structure A, the first indicating portion 331 may be visible from the outside of the mounting device 2 and when the mounting device 2 is properly fixed to the structure A, the second indicating portion 332 may be visible from the outside of the mounting device 2. Accordingly, through the first indicator 300, a user or the like can easily check with the naked eye whether the mounting device 2 is properly installed in the structure. It is possible to prevent defective installation of the mounting device 2. It is possible to improve the safety of use and the ease of use of the air conditioner 3. Further, it is possible to improve the performance of the air conditioner 3.

Meanwhile, the present disclosure is not limited to the above-described examples. For example, the first indicator 300 may be disposed on a portion of the frame forming the mounting device 2 and then be in contact the structure A corresponding to a portion of the frame. For example, the first indicator 300 may be disposed on the fixing frame 100 so as to be in contact with the lower portion 5 of the structure A. The first indicator 300 may be pressed by or against the lower portion 5 of the structure A. The first indicator 300 may indicate whether the fixing frame 100 is properly fixed to the structure A, and may be provided in a structure that is upside down and inverted from the structure of the first indicator 300 shown in the drawing. For example, the first indicator 300 may include a moving member that protrudes from the lower portion of the fixing frame 100 and is configured to move. For example, the moving member may include a push member exposed to the lower portion of the fixing frame 100 and an indicating panel coupled to the upper side of the push member.

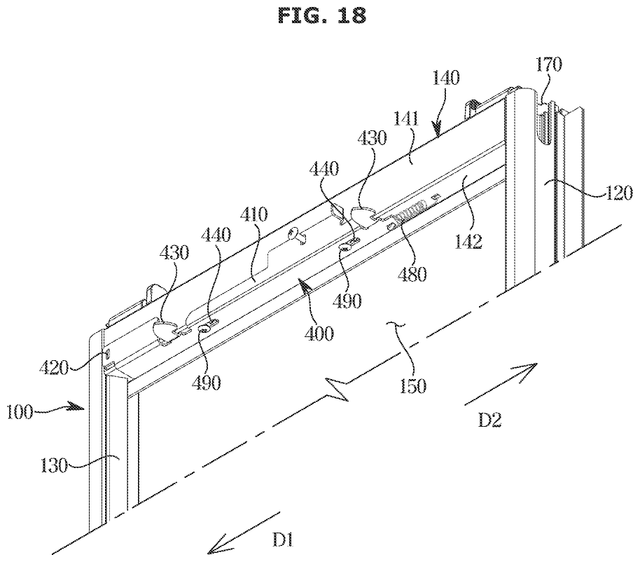

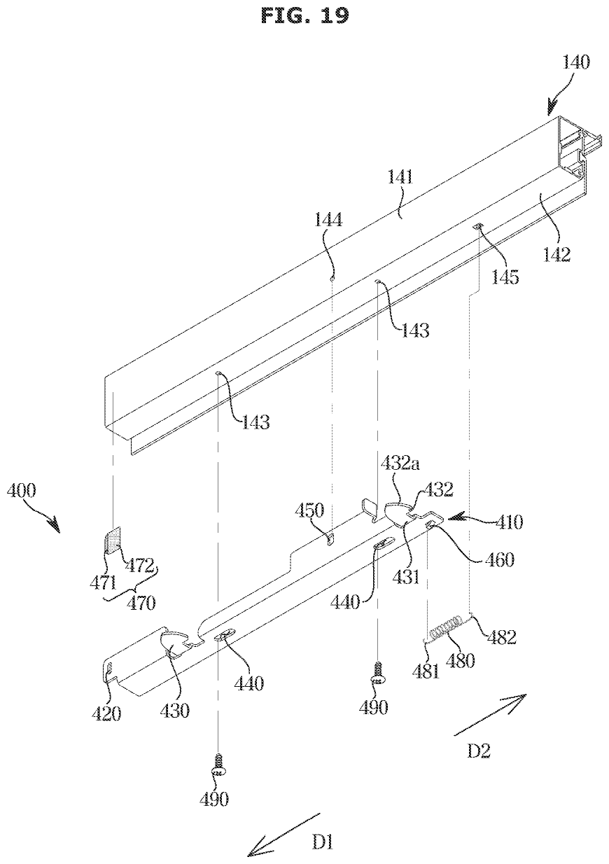

FIG. 18 is a partially enlarged view of the fixing frame according to an embodiment. FIG. 19 is a view illustrating a state in which a portion of the fixing frame and a second indicator according to an embodiment are disassembled.

The mounting device 2 may include a second indicator 400. The second indicator 400 may be configured to indicate whether the air conditioner 3 is mounted on the mounting device 2. For example, a user or the like can visually check whether the air conditioner 3 is properly assembled to the mounting device 2 through the second indicator 400.

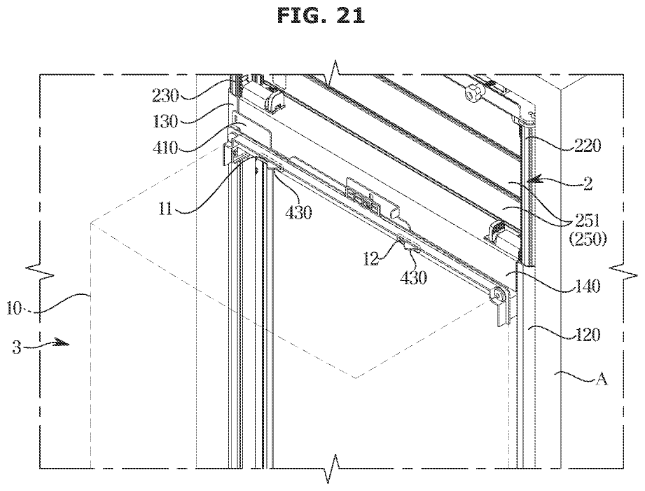

For example, the second indicator 400 may be disposed on the fixing frame 100. The second indicator 400 may be in contact with the air conditioner 3 (refer to FIGS. 21 to 29). The second indicator 400 may be in contact with the housing 10 of the air conditioner 3. At this time, the second indicator 400 may be configured to indicate whether the air conditioner 3 is properly fixed to the fixing frame 100.

The second indicator 400 may include a moving bracket 410. The moving bracket 410 may be configured to move with respect to the fixing frame 100. The moving bracket 410 may be configured to move relative to the fixing frame 100 by being pressed by or against the air conditioner 3 while the air conditioner 3 is mounted on the fixing frame 100. For example, the moving bracket 410 may be slidably movable with respect to the fixing frame 100.

For example, the moving bracket 410 may be disposed on the fourth frame portion 140 of the fixing frame 100. For example, the moving bracket 410 may move along the extension direction of the fourth frame portion 140 of the fixing frame 100. For example, the moving bracket 410 may move along the substantially horizontal direction (Y direction). For example, the moving bracket 410 may be provided to cover at least a portion of the fourth frame portion 140. For example, the moving bracket 410 may be provided to cover a portion of a front surface 141 and a portion of a bottom surface 142 of the fourth frame portion 140.

For example, the moving bracket 410 may be provided to cover an indicating panel 470, which will be described later. For example, the moving bracket 410 may be provided to cover a portion of the indicating panel 470. As will be described later, a second opening 420 formed in the moving bracket 410 may be provided to expose a portion of the indicating panel 470.

For example, the moving bracket 410 may include a guide hole 440 for guiding the movement of the moving bracket 410. The guide hole 440 may have a shape extending along a moving direction of the moving bracket 410. The moving bracket 410 may be configured to move along the extended length of the guide hole 440. For example, a length of the guide hole 440 in the horizontal direction (Y direction) may be greater than a length of the guide hole 440 in the front and rear direction (X direction).

For example, the guide hole 440 may be provided to correspond to a first fastening hole 143 formed on the bottom surface 142 of the fourth frame portion 140. A third fastening member 490 may pass through the guide hole 440 and be fastened to the first fastening hole 143. Accordingly, the moving bracket 410 may be configured to move with respect to the fourth frame portion 140 while being mounted on the fourth frame portion 140. The moving bracket 410 may be slidably supported on the fixing frame 100 by the third fastening member 490.

On the drawing, it is illustrated that two guide holes 440 are provided, but is not limited thereto. Alternatively, a single guide hole 440 may be provided. Alternatively, three or more guide holes 440 may be provided.

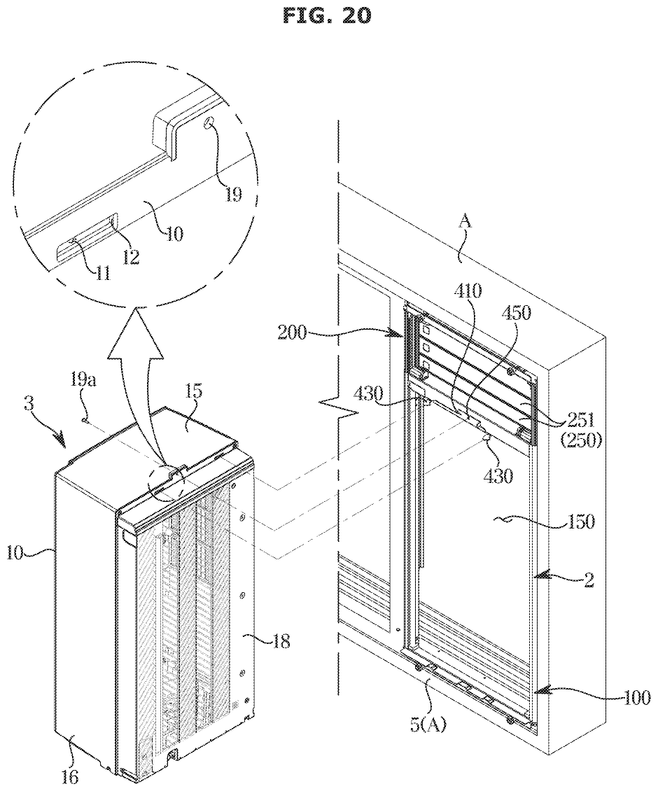

For example, the moving bracket 410 may include a corresponding hole 450. The corresponding hole 450 may be provided to correspond to a second fastening hole 144 formed on the front surface 141 of the fourth frame portion 140. The corresponding hole 450 may be provided to correspond to a third fastening hole 19 formed in the housing 10 of the air conditioner 3. For example, a fourth fastening member 19a may pass through the third fastening hole 19 of the air conditioner 3 and the corresponding hole 450 of the moving bracket 410, and then fastened to the second fastening hole 144 of the fixing frame 100 (refer to FIG. 20). For example, after the air conditioner 3 is mounted on the mounting device 2, the fourth fastening member 19a may be fastened to the second fastening hole 144.

The second indicator 400 may include the second opening 420. The second opening 420 may be formed in the moving bracket 410. The second opening 420 may be provided as a component of the moving bracket 410. The moving bracket 410 may include the second opening 420.

The second opening 420 may be configured to expose at least one of a third indicating portion 471 or a fourth indicating portion 472, which will be described later, to the outside of the fixing frame 100. For example, the second opening 420 may be provided to expose at least one of the third indicating portion 471 or the fourth indicating portion 472 to the outside of the fixing frame 100 based on whether a hook 430 of the moving bracket 410 is fixed to the housing 10 of the air conditioner 3. For example, the second opening 420 may be provided to correspond to a portion of the indicating panel 470. The second opening 420 may expose a portion of the indicating panel 470 to the outside of the moving bracket 410. The second opening 420 may be provided to expose at least one of the third indicating portion 471 or the fourth indicating portion 472 to the front of the moving bracket 410.

The second indicator 400 may include the hook 430. The moving bracket 410 may include the hook 430. The hook 430 may be provided to be inserted into a hook hole 11 (refer to FIGS. 3 and 20 to 29) formed in the air conditioner 3. The hook 430 may protrude from the moving bracket 410 toward the air conditioner 3. As will be described later, the hook 430 may be provided to be pressed by a hole edge portion 12 forming the hook hole 11. For example, the hook 430 may be provided to be pressed in a first direction D1 by the hole edge portion 12 forming the hook hole 11.

For example, the hook 430 may include a hook body 431 extending in a direction of being inserted into the hook hole 11. For example, the hook body 431 may protrude substantially forward (+X direction).

For example, the hook 430 may include a hook protrusion 432 protruding from the hook body 431 toward a second direction D2 opposite to the first direction D1. The hook protrusion 432 may be provided to be pressed by the hole edge portion 12 forming the hook hole 11.

For example, the hook protrusion 432 may include an inclined portion 432a. For example, the inclined portion 432a may be provided to be in contact with the hole edge portion 12 forming the hook hole 11. For example, the inclined portion 432a may have a shape inclined along the direction in which the hook 430 is inserted into the hook hole 11. For example, the hook protrusion 432 may include the inclined portion 432a and thus have a shape that gradually narrows along the direction in which the hook 430 is inserted into the hook hole 11. For example, the hook protrusion 432 may be easily inserted into the hook hole 11 of the air conditioner 3 due to the inclined portion 432a.

The second indicator 400 may include the indicating panel 470. The indicating panel 470 may include the third indicating portion 471 and the fourth indicating portion 472, which will be described later. For example, the indicating panel 470 may be disposed on the fixing frame 100. For example, the indicating panel 470 may be disposed on the front surface 141 of the fourth frame portion 140. For example, the indicating panel 470 may be detachably attached to the front surface 141 of the fourth frame portion 140.

The second indicator 400 may include the third indicating portion 471. The third indicating portion 471 may be visible from the outside of the fixing frame 100 when the air conditioner 3 is not fixed to the fixing frame 100.

The second indicator 400 may include the fourth indicating portion 472 distinct from the third indicating portion 471. The fourth indicating portion 472 may be visible from the outside of the fixing frame 100 when the air conditioner 3 is fixed to the fixing frame 100.

For example, the third indicating portion 471 and the fourth indicating portion 472 may be arranged along the moving direction of the moving bracket 410. For example, the fourth indicating portion 472 and the third indicating portion 471 may be arranged along the direction in which the moving bracket 410 is pressed by or against the air conditioner 3. For example, the fourth indicating portion 472 and the third indicating portion 471 may be arranged in the first direction D1 in which the hole edge portion 12 forming the hook hole 11 of the air conditioner 3 presses the hook 430 of the moving bracket 410. For example, the third indicating portion 471 and the fourth indicating portion 472 may be arranged along the substantially horizontal direction (Y direction).

The third indicating portion 471 and the fourth indicating portion 472 may be distinguished from each other. For example, the third indicating portion 471 may include a third color, and the fourth indicating portion 472 may include a fourth color different from the third color. Alternatively, the third indicating portion 471 may include a third pattern, and the fourth indicating portion 472 may include a fourth pattern different from the third pattern. Alternatively, the third indicating portion 471 may include a third symbol, and the fourth indicating portion 472 may include a fourth symbol different from the third symbol. Alternatively, the third indicating portion 471 may include a third texture, and the fourth indicating portion 472 may include a fourth texture different from the third texture. The present disclosure is not limited to the above-described examples, and it is sufficient that the third indicating portion 471 and the fourth indicating portion 472 are identified as being different from each other.

The second indicator 400 may include a second spring 480. The second spring 480 may be configured to elastically bias the moving bracket 410.

For example, the second spring 480 may be configured to elastically bias the moving bracket 410 toward a direction opposite to the direction in which the air conditioner 3 presses the moving bracket 410. For example, the second spring 480 may be configured to elastically bias the moving bracket 410 toward the second direction D2 opposite to the first direction D1 in which the hole edge portion 12 forming the hook hole 11 of the air conditioner 3 presses the hook 430 of the moving bracket 410.

One end 481 of the second spring 480 may be coupled to the moving bracket 410. The other end 482 of the second spring 480 may be coupled to the fixing frame 100. For example, the one end 481 of the second spring 480 may be coupled to a spring fixing portion 460 formed on the moving bracket 410. For example, the other end 482 of the second spring 480 may be coupled to a spring fixing portion 145 formed in the fourth frame portion 140.

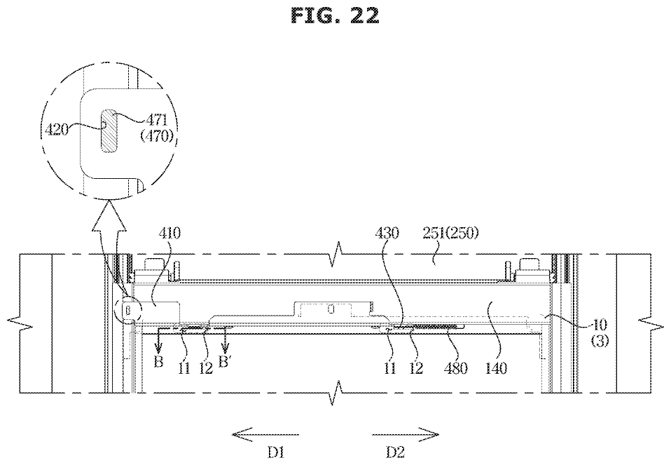

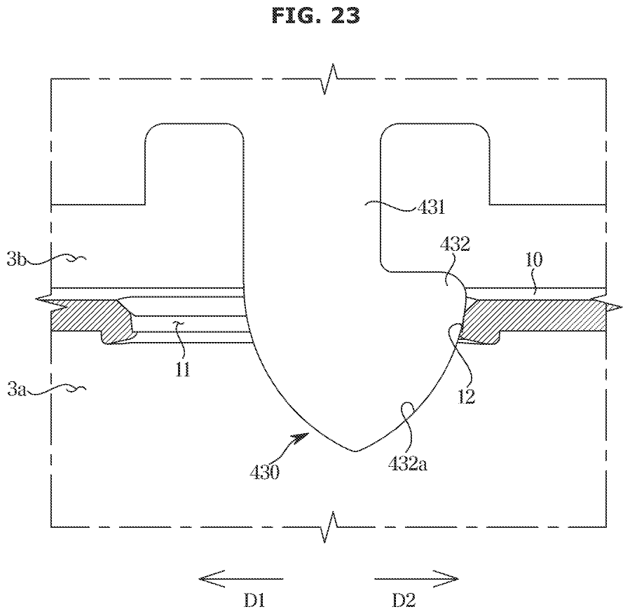

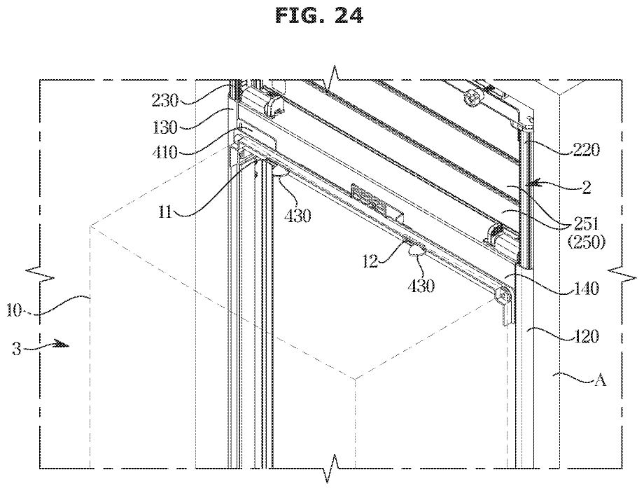

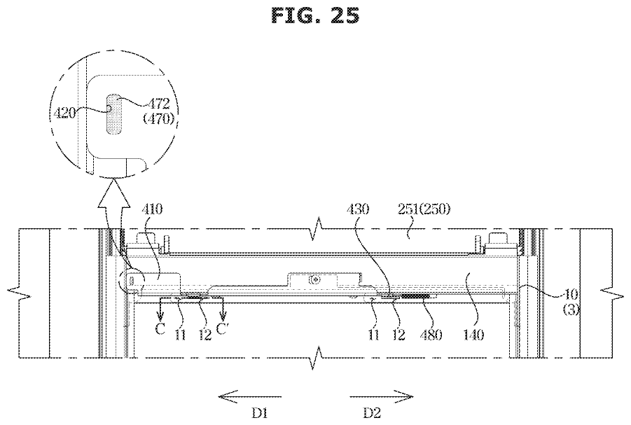

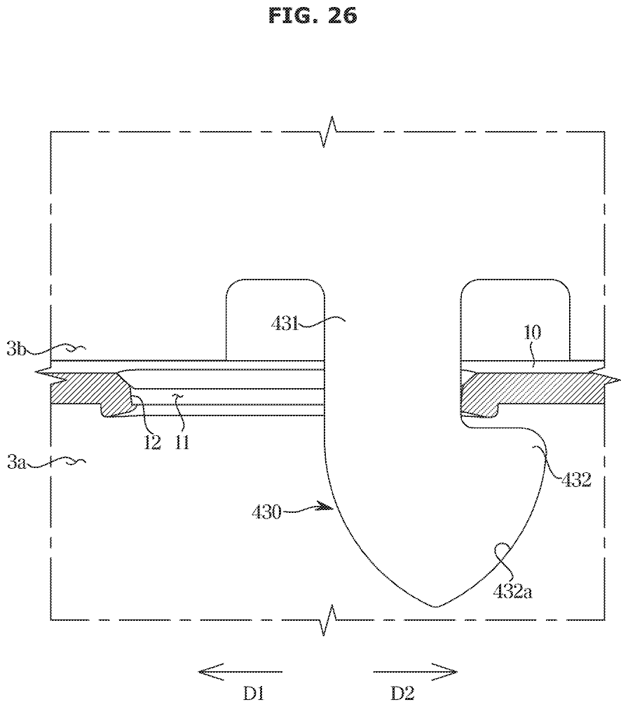

FIG. 20 is a view illustrating an example in which the air conditioner is mounted on the mounting device. FIG. 21 is a view illustrating an example in which the air conditioner is not fixed to the mounting device. FIG. 22 is a view schematically illustrating a portion of a front surface of the state shown in FIG. 21. FIG. 23 is a planar cross-sectional view taken along line B-B′ shown in FIG. 22. FIG. 24 is a view illustrating an example in which the air conditioner is fixed to the mounting device. FIG. 25 is a view schematically illustrating a portion of a front surface of the state shown in FIG. 24. FIG. 26 is a planar cross-sectional view taken along line C-C′ shown in FIG. 25.

Referring to FIG. 20, the housing 10 of the air conditioner 3 may be mounted on the mounting device 2. The housing 10 of the air conditioner 3 may be held on the fixing frame 100. The housing 10 of the air conditioner 3 may correspond to the mounting opening 150 of the fixing frame 100. At least a portion of the housing 10 of the air conditioner 3 may be inserted into the mounting opening 150.

The air conditioner 3 may include the hook hole 11. The hook hole 11 may be formed in the housing 10. The hook hole 11 may be formed to penetrate the housing 10. For example, the hook hole 11 may allow an inside 3a to communicate with an outside 3b of the air conditioner 3. For example, the hook hole 11 may allow the inside to communicate with the outside of the housing 10.

The air conditioner 3 may include the hole edge portion 12. The hole edge portion 12 may be formed in the housing 10. The hole edge portion 12 may form the hook hole 11. The hole edge portion 12 may define the hook hole 11.

The hook hole 11 of the air conditioner 3 may be provided to correspond to the hook 430 of the moving bracket 410. While the air conditioner 3 is being mounted on the mounting device 2, the hook 430 may be inserted into the hook hole 11. When the air conditioner 3 is completely mounted on the mounting device 2, the hook 430 may be fixed to the housing 10 through the hook hole 11.

On the drawing, it is illustrated that two hook holes 11 of the air conditioner 3 and two hooks 430 of the moving bracket 410 are provided, but is not limited thereto. Alternatively, a single hook hole 11 of the air conditioner 3 and a single hook 430 of the moving bracket 410 may be provided. Alternatively, three or more hook holes 11 of the air conditioner 3 and three or more hooks 430 of the moving bracket 410 may be provided.

Referring to FIGS. 21 to 23, the moving bracket 410 may be configured to move in the first direction D1 as the hook 430 is pressed by the hole edge portion 12 forming the hook hole 11.

For example, while the air conditioner 3 is mounted on the fixing frame 100, the hook 430 may enter the inside 3a of the air conditioner 3 through the hook hole 11. At this time, the hook 430 may be pressed in the first direction D1 by the hole edge portion 12. The moving bracket 410 including the hook 430 may move in the first direction D1 with respect to the fixing frame 100. The hook protrusion 432 of the hook 430 may be provided to be in contact with the hole edge portion 12. A portion of the hook protrusion 432 of the hook 430 may be located in the inside 3a of the air conditioner 3, and the other portion of the hook protrusion 432 of the hook 430 may be located on the outside 3b of the air conditioner 3. A portion of the hook protrusion 432 of the hook 430 may be located inside the housing 10, and the other portion of the hook protrusion 432 of the hook 430 may be located outside the housing 10.

As the moving bracket 410 moves in the first direction D1, the third indicating portion 471 may be visible from the outside of the mounting device 2. That is, when the air conditioner 3 is not completely fixed to the mounting device 2, the third indicating portion 471 may be visible from the outside of the mounting device 2. For example, while the air conditioner 3 is being mounted on the fixing frame 100, the third indicating portion 471 may be provided to be exposed to the outside of the fixing frame 100. For example, when the air conditioner 3 is not completely mounted on the fixing frame 100, the third indicating portion 471 may be exposed to the front of the mounting device 2. For example, when the air conditioner 3 is not completely mounted on the fixing frame 100, the third indicating portion 471 may be exposed to the outside of the moving bracket 410 through the second opening 420.

As the moving bracket 410 moves in the first direction D1, the second spring 480 may be extended. The one end 481 of the second spring 480 may move in the first direction D1 together with the moving bracket 410. The other end 482 of the second spring 480 may be maintained in a state of being fixed to the fixing frame 100.

Referring to FIGS. 24 to 26, when the hook 430 is fixed to the air conditioner 3 through the hook hole 11, the moving bracket 410 may move in the second direction D2 opposite to the first direction D1. When the hook 430 is fixed to the housing 10 through the hook hole 11, the moving bracket 410 may be configured to move in the second direction D2 opposite to the first direction D1. The moving bracket 410 may be configured to move in the second direction D2 by the second spring 480.

For example, when the air conditioner 3 is completely mounted on the fixing frame 100, the hook protrusion 432 of the hook 430 may pass through the hook hole 11. At this time, the hole edge portion 12 may not press the hook 430, and the moving bracket 410 including the hook 430 may move in the second direction D2 by the elastic restoring force of the second spring 480. The hook body 431 of the hook 430 may be in contact with the hole edge portion 12. The hook protrusion 432 of the hook 430 may pass through the hook hole 11 and be caught on the housing 10. The hook protrusion 432 of the hook 430 may be located in the inside 3a of the air conditioner 3. The hook protrusion 432 of the hook 430 may be located inside the housing 10.

As the moving bracket 410 moves in the second direction D2, the fourth indicating portion 472 may be visible from the outside of the mounting device 2. That is, when the air conditioner 3 is completely fixed to the mounting device 2, the fourth indicating portion 472 may be visible from the outside of the mounting device 2. For example, when the air conditioner 3 is held on the fixing frame 100, the fourth indicating portion 472 may be exposed to the outside of the fixing frame 100. For example, when the air conditioner 3 is completely mounted on the fixing frame 100, the fourth indicating portion 472 may be exposed to the front of the mounting device 2. For example, when the air conditioner 3 is completely mounted on the fixing frame 100, the fourth indicating portion 472 may be exposed to the outside of the moving bracket 410 through the second opening 420.

Referring to FIGS. 21 to 26, the second indicator 400 may be configured to allow the third indicating portion 471 to be switched to the fourth indicating portion 472 so as to allow the fourth indicating portion 472 to be visible in the process of mounting the air conditioner 3 to the mounting device 2. For example, in the process of mounting the air conditioner 3 to the mounting device 2, a user or the like can determine that the air conditioner 3 is mounted on mounting device 2 by confirming that the third indicating portion 471 is switched to the fourth indicating portion 472. For example, conversely, a user or the like can determine that the air conditioner 3 is separated from the mounting device 2 by confirming that the fourth indicating portion 472 is switched to the third indicating portion 471. For example, when both the third indicating portion 471 and the fourth indicating portion 472 are visible from the outside of the fixing frame 100, a user or the like can determine that the air conditioner 3 is not properly fixed to the mounting device 2. For example, when both the third indicating portion 471 and the fourth indicating portion 472 are visible from the outside of the fixing frame 100, a user or the like can determine that the air conditioner 3 is less fixed to the fixing frame 100. For example, when both the first indicating portion 331 and the second indicating portion 332 are visible from the outside of the fixing frame 100, a user or the like can recognize that it is required for the air conditioner 3 to be closer contact with the fixing frame 100.

The second spring 480 may be configured to elastically bias the moving bracket 410 toward the second direction D2. The one end 481 of the second spring 480 may move in the second direction D2 together with the moving bracket 410. The other end 482 of the second spring 480 may be maintained in a state of being fixed to the fixing frame 100.

In general, it is important to mount the air conditioner to the mounting device. For example, when the air conditioner is not properly mounted on the mounting device, the air conditioner may not be mounted stably on the mounting device. For example, the air conditioner may be damaged by falling from the mounting device. For example, a user or the like can collide with the air conditioner. However, it may not be easy to check whether the air conditioner is properly installed in the mounting device. Criteria for determining whether the air conditioner is installed may not be intuitive. For example, a user or the like can determine whether the air conditioner is fixed to the mounting device based on sense. For example, it may be difficult for a user or the like to visually check a part where the air conditioner is fixed to the mounting device. Therefore, there is a limit to checking for defective installation of the air conditioner.

However, according to the present disclosure, it is possible to easily check whether the air conditioner 3 is properly mounted on the mounting device 2. For example, the indication of the second indicator 400 may vary depending on whether the air conditioner 3 is properly installed in the mounting device 2. For example, when the air conditioner 3 is not properly fixed to the mounting device 2, the third indicating portion 471 may be visible from the outside of the mounting device 2 and when the air conditioner 3 is properly fixed to the mounting device 2, the fourth indicating portion 472 may be visible from the outside of the mounting device 2. Accordingly, through the second indicator 400, a user or the like can easily check with the naked eye whether the air conditioner 3 is properly installed in the mounting device 2. It is possible to prevent defective installation of the mounting device 2. It is possible to improve the safety of use and the ease of use of the air conditioner 3. Further, it is possible to improve the performance of the air conditioner 3.

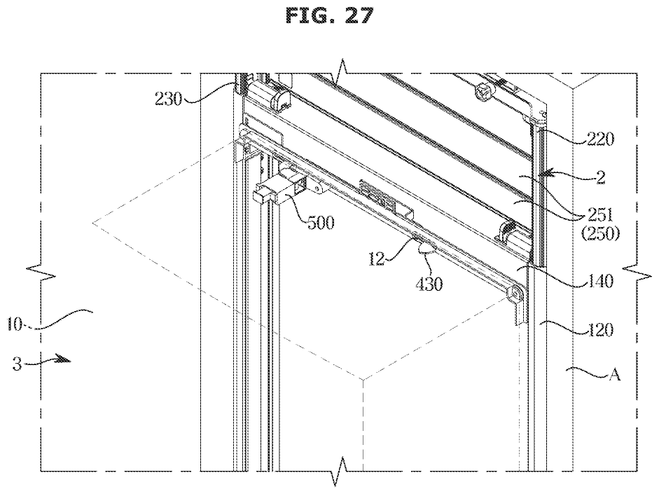

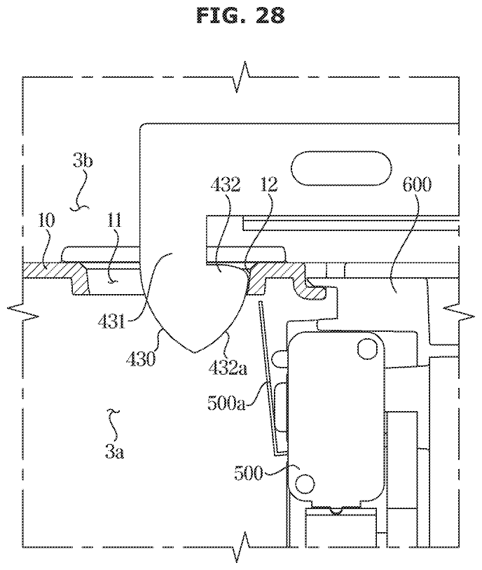

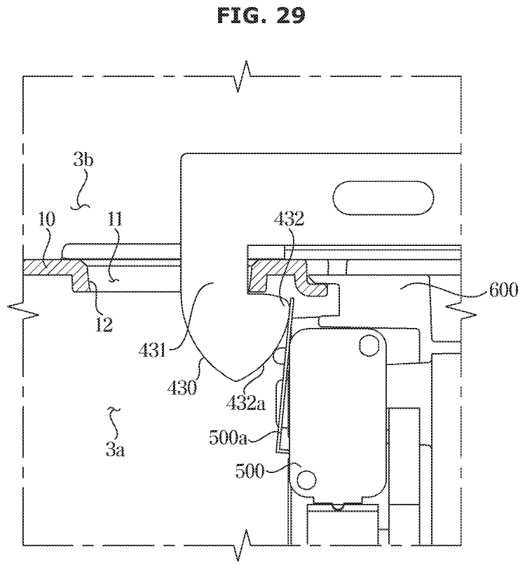

FIG. 27 is a view schematically illustrating an example in which the air conditioner according to an embodiment includes a switch. FIG. 28 is a view schematically illustrating a portion of a planar cross-section of the air conditioner shown in FIG. 27 when the air conditioner is not fixed to the mounting device. FIG. 29 is a view schematically illustrating a portion of a planar cross-section of the air conditioner shown in FIG. 27 when the air conditioner is fixed to the mounting device.

Referring to FIG. 27, the air conditioner 3 may further include a switch 500. The switch 500 may be disposed inside the housing 10 of the air conditioner 3. The switch 500 may be disposed adjacent to the hook hole 11. The switch 500 may be disposed adjacent to the hole edge portion 12. The switch 500 may be provided to be held on the housing 10 by a holder 600. For example, the holder 600 may be detachably coupled to the housing 10. However, the present disclosure is not limited thereto, and the holder 600 may be formed integrally with the housing 10.

Referring to FIG. 28, when the air conditioner 3 is not fixed to the mounting device 2, the hook 430 may not be in contact with a terminal 500a of the switch 500. That is, when the air conditioner 3 is not completely fixed to the fixing frame 100, the hook 430 may not be in contact with the terminal 500a of the switch 500. When the hook protrusion 432 of the hook 430 passes through the hook hole 11 and is not fixed to the housing 10, the hook 430 may not interfere with the terminal 500a of the switch 500.

In response to the hook 430 not being in contact with the terminal 500a of the switch 500, the switch 500 may detect that the air conditioner 3 is not fixed to the mounting device 2. For example, the switch 500 may generate a signal corresponding to the fact that the hook 430 is not in contact with the terminal 500a of the switch 500, and the switch 500 may transmit the generated signal to a controller of the air conditioner 3. For example, the controller of the air conditioner 3 may output information corresponding to the signal received from the switch 500 through an output interface. For example, a user or the like can intuitively recognize that the air conditioner 3 is not fixed to the mounting device 2 through the output interface.

Referring to FIG. 29, when the air conditioner 3 is fixed to the mounting device 2, the hook 430 may be in contact with the terminal 500a of the switch 500. That is, when the air conditioner 3 is completely fixed to the fixing frame 100, the hook 430 may be in contact with the terminal 500a of the switch 500. When the hook protrusion 432 of the hook 430 passes through the hook hole 11 and is fixed to the housing 10, the hook 430 may interfere with the terminal 500a of the switch 500.

In response to the hook 430 being in contact with the terminal 500a of the switch 500, the switch 500 may detect that the air conditioner 3 is fixed to the mounting device 2. For example, the switch 500 may generate a signal corresponding to the contact between the hook 430 and the terminal 500a of the switch 500, and the switch 500 may transmit the generated signal to the controller of the air conditioner 3. For example, the controller of the air conditioner 3 may output information corresponding to the signal received from the switch 500 through the output interface. For example, a user or the like can intuitively recognize that the air conditioner 3 is fixed to the mounting device 2 through the output interface.

According to an embodiment, the mounting device 2 configured to mount the air conditioner 3 on the window frame A may include the fixing frame 100 provided to hold the air conditioner and configured to be fixable to the lower portion 5 of the window frame A, the moving frame 200 configured to move up and down with respect to the fixing frame and configured to be fixable to the upper portion 4 of the window frame, and the indicator 300 disposed on the moving frame and configured to be in contact with the upper portion of the window frame. The indicator 300 may include the first indicating portion 331 provided to be visible from the outside of the moving frame in response to the moving frame not being fixed to the upper portion of the window frame. The indicator 300 may include the second indicating portion 332 distinct from the first indicating portion, and provided to be visible from the outside of the moving frame in response to the moving frame being fixed to the upper portion of the window frame.

The indicator 300 may be configured to allow the first indicating portion 331 to be switched to the second indicating portion 332 so as to allow the second indicating portion 332 to be visible from the outside of the moving frame as the indicator is pressed by or against the upper portion of the window frame.

The indicator 300 may include the moving member 310 provided to protrude from the moving frame, and configured to be movable by being pressed by or against the upper portion of the window frame. The moving member 310 may include the first indicating portion 331 and the second indicating portion 332.

The indicator 300 may include the spring 340 configured to elastically bias the moving member toward the upper portion 4 of the window frame.

The moving member 310 may be configured to move between the first position P1 maximally protruding from the moving frame and the second position P2 pressed from the first position by the upper portion of the window frame.

The first indicating portion 331 may be located below the second indicating portion 332. In response to the moving member being in the first position P1, the first indicating portion 331 may be exposed to the outside of the moving frame. In response to the moving member being in the second position P2, the second indicating portion 332 may be exposed to the outside of the moving frame.

The moving member 310 may include the contact portion 321 exposed to the outside of the moving frame and provided to be in contact with the upper portion of the window frame. The moving member 310 may include the indicating panel 330 downwardly away from the contact portion and including the first indicating portion and the second indicating portion. The moving member 310 may include the connection portion 323 provided to connect the contact portion and the indicating panel.

The moving frame 200 may include the first side frame portion 220 extending along the moving direction of the moving frame. The moving frame 200 may include the second side frame portion 230 extending parallel to the first side frame portion. The moving frame 200 may include the upper frame portion 240 provided to connect the first side frame portion and the second side frame portion and provided to be fixed to the upper portion of the window frame. The moving frame 200 may include the screen 250 configured to cover a region surrounded by the fixing frame, the first side frame portion, the second side frame portion, and the upper frame portion, and provided to accommodate the indicating panel. The moving frame 200 may include the opening 252 formed in the screen 250 and provided to expose at least one of the first indicating portion or the second indicating portion to the outside of the screen.

The first indicating portion may include the first color, and the second indicating portion may include the second color different from the first color.

The indicator may be the first indicator 300. The mounting device 2 may include the second indicator 400 disposed in the fixing frame. The second indicator 400 may include the third indicating portion 471 provided to be visible from the outside of the fixing frame in response to the air conditioner not being fixed to the fixing frame. The second indicator 400 may include the fourth indicating portion 472 distinct from the third indicating portion and provided to be visible from the outside of the fixing frame in response to the air conditioner being fixed to the fixing frame.

The second indicator 400 may include the moving bracket 410 configured to be movable with respect to the fixing frame by being pressed by or against the air conditioner while the air conditioner is mounted on the fixing frame. The second indicator 400 may include the opening 420 formed on the moving bracket and provided to expose at least one of the third indicating portion or the fourth indicating portion to the outside of the fixing frame.

The second indicator 400 may include the spring 480 including one end coupled to the moving bracket, and the other end coupled to the fixing frame.

The moving bracket may include the hook 430 provided to be inserted into the hook hole 11 formed in the air conditioner. The moving bracket may be configured to move in the first direction D1 while the hook is pressed by the hole edge portion 12 forming the hook hole. The moving bracket may be configured to move in the second direction D2 opposite to the first direction by the spring 480 in response to the hook being fixed to the air conditioner through the hook hole.

The hook may include the hook body 431 extending in a direction of being inserted into the hook hole, and the hook protrusion 432 protruding from the hook body toward the second direction and provided to be pressed by the hole edge portion.

The third indicating portion 471 may include the first color, and the fourth indicating portion 472 may include the second color different from the first color.

According to an embodiment, the mounting device configured to mount the air conditioner including the housing 10 and the hook hole 11 formed in the housing, the mounting device may include the fixing frame 100 provided to hold the housing of the air conditioner, the indicating panel 470 disposed on the fixing frame and including the first indicating portion 471 and the second indicating portion 472 distinct from the first indicating portion, and the moving bracket 410 configured to be movable with respect to the fixing frame 100 and provided to cover the indicating panel. The moving bracket 410 may include the hook 430 configured to be fixed to the housing through the hook hole. The moving bracket 410 may include the opening 420 provided to expose at least one of the first indicating portion 471 or the second indicating portion 472 to the outside of the fixing frame 100 based on whether the hook 430 is fixed to the housing 10.

The moving bracket 410 may be configured to move toward the first direction D1 while the hook is pressed by the hole edge portion forming the hook hole. The moving bracket 410 may be configured to move toward the second direction D2 opposite to the first direction by the spring 480 in response to the hook being fixed to the housing through the hook hole.

The mounting device may include the spring 480 configured to elastically bias the moving bracket to the second direction. One end of the spring 480 may be coupled to the moving bracket, and the other end of the spring 480 may be coupled to the fixing frame.

According to an embodiment, the air conditioning apparatus 1 may include the air conditioner 3 and the mounting device 2 configured to mount the air conditioner 3 on a structure. The mounting device 2 may include the frame configured to be mounted on the structure, and the moving member 310 protruding from the frame. The moving member 310 may be configured to move between the first position P1 and the second portion P2 pressed from the first position by the structure, and include the first indicating portion 331 and the second indicating portion 332 distinct from the first indicating portion. In response to the moving member being in the first position P1, the first indicating portion 331 may be exposed to the outside of the frame and in response to the moving member being in the second position P2, the second indicating portion 332 may be exposed to the outside of the frame.

The first indicating portion 331 and the second indicating portion 332 may be arranged along the moving direction of the moving member 310.

According to one or more embodiments of the present disclosure, a user can easily check whether a mounting device is mounted.

According to one or more embodiments of the present disclosure, a user can easily check whether an air conditioner is installed.

According to one or more embodiments of the present disclosure, it is possible to prevent incorrect installation of a mounting device.

According to one or more embodiments of the present disclosure, it is possible to prevent incorrect installation of an air conditioner.

According to one or more embodiments of the present disclosure, it is possible to improve convenience of use because an air conditioning apparatus include an improved structure.

According to one or more embodiments of the present disclosure, it is possible to improve the safety of use because an air conditioning apparatus include an improved structure

Additional aspects of the disclosure will be set forth in part in the description which follows and, in part, will be obvious from the description, or may be learned by practice of the disclosure.

While the present disclosure has been particularly described with reference to example embodiments, it should be understood by those of skilled in the art that various changes in form and details may be made without departing from the spirit and scope of the present disclosure.

What is claimed is:

1. A mounting device configured to mount an air conditioner on a window frame, the mounting device comprising:
a fixing frame configured to hold the air conditioner and to be fixable to a lower portion of the window frame;
a moving frame configured to move up and down with respect to the fixing frame and to be fixable to an upper portion of the window frame; and
an indicator disposed on the moving frame and configured to contact the upper portion of the window frame,
wherein the indicator comprises:
a first indicating portion configured to be visible from an outside of the moving frame when the moving frame is not fixed to the upper portion of the window frame; and
a second indicating portion that is different from the first indicating portion, and configured to be visible from the outside of the moving frame when the moving frame is fixed to the upper portion of the window frame.

2. The mounting device of claim 1, wherein the indicator is configured to switch from a display to the outside of the moving frame of the first indicating portion to a display to the outside of the moving from of the second indicating portion based on the indicator being pressed against the upper portion of the window frame.

3. The mounting device of claim 1, wherein the indicator further comprises a moving member protruding from the moving frame and configured to be movably pressed against the upper portion of the window frame, and
wherein the moving member comprises the first indicating portion and the second indicating portion.

4. The mounting device of claim 3, wherein the indicator further comprises a spring configured to elastically bias the moving member toward the upper portion of the window frame.

5. The mounting device of claim 3, wherein the moving member is further configured to move between a first position maximally protruding from the moving frame and a second position pressed from the first position through contact with the upper portion of the window frame.

6. The mounting device of claim 5, wherein the first indicating portion is below the second indicating portion,
wherein, when the moving member is in the first position, the first indicating portion is exposed to the outside of the moving frame; and
wherein, when the moving member is in the second position, the second indicating portion is exposed to the outside of the moving frame.

7. The mounting device of claim 3, wherein the moving member further comprises:
a contact portion exposed to the outside of the moving frame and configured to be in contact with the upper portion of the window frame;
an indicating panel below the contact portion and comprising the first indicating portion and the second indicating portion; and
a connection portion connecting the contact portion and the indicating panel.

8. The mounting device of claim 7, wherein the moving frame comprises:
a first side frame portion extending along a moving direction of the moving frame;
a second side frame portion extending parallel to the first side frame portion;
an upper frame portion connecting the first side frame portion and the second side frame portion and configured to be fixed to the upper portion of the window frame;
a screen covering a region surrounded by the fixing frame, the first side frame portion, the second side frame portion, and the upper frame portion, and accommodating the indicating panel; and
an opening provided in the screen and exposing at least one of the first indicating portion or the second indicating portion to an outside of the screen.

9. The mounting device of claim 1, wherein the first indicating portion comprises a first color; and
the second indicating portion comprises a second color that is different from the first color.

10. The mounting device of claim 1, wherein the indicator is a first indicator,
wherein the mounting device further comprises a second indicator in the fixing frame, and
wherein the second indicator comprises:
a third indicating portion configured to be visible from an outside of the fixing frame when the air conditioner is not fixed to the fixing frame; and
a fourth indicating portion distinct from the third indicating portion and configured to be visible from the outside of the fixing frame when the air conditioner is fixed to the fixing frame.

11. The mounting device of claim 10, wherein the second indicator comprises:
a moving bracket configured to be movable with respect to the fixing frame by being pressed by the air conditioner while the air conditioner is mounted on the fixing frame; and
an opening formed on the moving bracket and configured to expose at least one of the third indicating portion or the fourth indicating portion to the outside of the fixing frame.

12. The mounting device of claim 11, wherein the second indicator further comprises a spring comprising one end coupled to the moving bracket and another end coupled to the fixing frame.

13. The mounting device of claim 12, wherein the moving bracket further comprises a hook configured to be inserted into a hook hole formed in the air conditioner,
wherein the moving bracket is configured to move in a first direction while the hook is pressed against a hole edge portion forming the hook hole, and
wherein the spring is configured to move the moving bracket in a second direction opposite to the first direction when the hook is fixed to the air conditioner through the hook hole.

14. The mounting device of claim 13, wherein the hook comprises:
a hook body configured to be inserted into the hook hole; and
a hook protrusion protruding from the hook body toward the second direction and configured to be pressed against the hole edge portion.

15. The mounting device of claim 10, wherein the third indicating portion comprises a first color; and
the fourth indicating portion comprises a second color that is different from the first color.

16. A mounting device configured to mount an air conditioner on a window frame, the mounting device comprising:
a fixing frame configured to hold the air conditioner and to be fixable to a lower portion of the window frame; and
an indicator in the fixing frame, the indicator comprising:
a first indicating portion configured to be visible from an outside of the fixing frame when the air conditioner is not fixed to the fixing frame; and
a second indicating portion distinct from the first indicating portion and configured to be visible from the outside of the fixing frame when the air conditioner is fixed to the fixing frame.

17. The mounting device of claim 16, wherein the indicator comprises:
a moving bracket configured to be movable with respect to the fixing frame by being pressed by the air conditioner; and
an opening formed on the moving bracket and configured to expose at least one of the first indicating portion or the second indicating portion to the outside of the fixing frame.

18. The mounting device of claim 17, wherein the indicator further comprises a spring comprising one end coupled to the moving bracket and another end coupled to the fixing frame.

19. The mounting device of claim 18, wherein the moving bracket further comprises a hook configured to be inserted into a hook hole formed in the air conditioner,
wherein the moving bracket is configured to move in a first direction while the hook is pressed against a hole edge portion forming the hook hole, and
wherein the spring is configured to move the moving bracket in a second direction opposite to the first direction when the hook is fixed to the air conditioner through the hook hole.

20. The mounting device of claim 19, wherein the hook comprises:
a hook body configured to be inserted into the hook hole; and
a hook protrusion protruding from the hook body toward the second direction and configured to be pressed against the hole edge portion.
